(19) United States
(12) Patent Application Publication
(10) Pub. No.: US 2003/0200309 A1
(43) Pub. Date: Oct. 23, 2003

(54) Transmission network system

(76) Inventors: Hiroyuki Ohhashi, Yokohama (JP); Eiji Ishizaka, Yokohama (JP); Tatsuo Yamaguchi, Yokohama (JP); Nobuo Sashida, Yokohama (JP)

Correspondence Address: KATTEN MUCHIN ZAVIS ROSENMAN, 575 MADISON AVENUE, NEW YORK, NY, 10022-2585, US

(21) Appl. No.: 10/345,869

(22) Filed: Jan. 16, 2003

(30) Foreign Application Priority Data
Apr. 23, 2002 (JP) 2002-120647

(51) Int. Cl. G06F 15/173

(52) U.S. Cl. 709/224

(57) ABSTRACT

Such problems as that a serious alarm occurring on a network can be recognized in real time by a limited number of maintenance staff, and that the information related to a package housing change cannot be known by a maintenance staff actually operating in front of a transmission apparatus are avoided in a transmission network system, which includes a plurality of transmission apparatus connected to a network; and a supervision and control operation system connected to the network, the supervision and control operation system including a means for transmitting information related to a network alarm or a package housing change, which is detected by the transmission apparatus to a predetermined mail address via an electronic mail.

### FIELD OF THE INVENTION

The present invention relates to a transmission network system having a supervision and control operation system (OpS) disposed on the upper level of a plurality of transmission apparatus (or NE; network elements) for supervision and control of these transmission apparatus.

### BACKGROUND OF THE INVENTION

FIG. 1 shows a conventional transmission network system configuration constituted of a plurality of transmission apparatus and a supervision and control operation system. A supervision and control operation system 1 is disposed on the upper level of a plurality (e.g. 20 to 100 sets) of transmission apparatus 2 (#1, #2, . . . #N). The purpose is to control package registration and line setting, etc. of transmission apparatus 2 and to collect an alarm sent from transmission apparatus 2 and information on package housing change, etc.

Supervision and control operation system 1 is provided with a GUI (graphical user interface) unit 10 having a screen for controlling against transmission apparatus 2 and for displaying notification information sent from transmission apparatus 2.

To this supervision and control operation system 1, remote supervision and control terminals 3 (#1, #2, . . . #N) each having GUI unit 30 similar to the aforementioned GUI unit 10 are connected. Using these remote supervision and control terminals 3, it is also possible to execute control and display notification information.

In other cases, when there are a plurality of systems each constituting of supervision and control operation system 1 and transmission apparatus 2 shown in FIG. 1, a network supervision terminal may be provided for integrally supervising these systems.

The processing details performed in the above-mentioned system are described below.

(1) Alarm information in network fault information (A) including a network alarm produced in a circuit network having the plurality of transmission apparatus 2 (#1, #2, . . . #N) shown in FIG. 1 and a physical fault alarm of transmission apparatus 2 are detected by transmission apparatus 2. Such alarm is reported to supervision and control operation system 1.

Supervision and control operation system 1 displays the reported alarm information on a screen 110 through the own GUI unit 10, or informs remote supervision and control terminal 3 connected to supervision and control operation system 1 to display on GUI unit 30 of remote supervision and control terminal 3. Thus the information is notified to maintenance staff.

The alarm information is transmitted to a network supervision terminal 4 when the terminal 4 exists, to notify maintenance staff in a similar manner.

(2) As for package housing change information (B) produced in transmission apparatus 2 shown in FIG. 1, the information is sent to supervision and control operation system 1 similar to above (1). Supervision and control operation system 1 notifies maintenance staff by displaying the package housing change information B onto a screen by the own GUI unit 10. Otherwise, the information is sent to remote supervision and control terminal 3 connected to supervision and control operation system 1 to display on the screen of GUI unit 30 of remote supervision and control terminal 3. Thus the information is sent to maintenance staff.

(3) Further, when a fault occurs on an application program or other related software in supervision and control operation system 1 (such as the OS and database management software), supervision and control operation system 1 generates a software fault information file (C) to record into this file the information necessary for fault analysis including locating the fault point, finding out the cause of the fault, etc. This software fault information file is preserved in a hard disk of the terminal which is activated by supervision and control operation system 1.

Also, when a staff in charge of analysis refers to the above-mentioned software fault information file to find out the cause of the fault, the file of interest is collected from the hard disk in which the file is preserved through the maintenance staff each time the analysis is made.

(4) In FIG. 1, when supervision and control operation system 1 is provided with a database, an application program in supervision and control operation system 1 periodically generates a backup file to preserve in either a hard disk or an external storage 11 provided in the terminal which is activated by supervision and control operation system 1.

When a fault occurs in the database of supervision and control operation system 1, the above-mentioned database backup information (hereinafter referred to as DB information) is read out from the hard disk or external storage 11 to restore the information. Thus the database is recovered.

Also, at this time, in order to identify the cause of the fault, a staff in charge of analysis obtains the above-mentioned DB backup information file to conduct analysis and survey by restoring the information onto a non-illustrated terminal for analysis.

Because the capacity of the hard disk or the external storage preserving this DB backup information is finite, a storage limit is provided. When the data is to exceed the capacity, the DB backup information file contents are successively deleted in order of the length of time stored.

(5) As for the operation information issued from GUI unit 10 or remote supervision and control terminal 3 toward supervision and control operation system 1, such information is stored into the hard disk or external storage 11 activated by supervision and control operation system 1 as an operation history.

Also, as for control and supervision information transferred from supervision and control operation system 1 to remote supervision and control terminal 3, network supervision terminal 4 and transmission apparatus 2, and vice versa, such information is also filed in the hard disk or the external storage as a communication history.

Here, similar to the aforementioned case (4), the history file cannot be preserved infinitely because of the capacity limit. Therefore a storage limit is provided, and when the capacity is to exceed, the history file contents are successively deleted in order of the length of time stored.

Further, whenever each of the above-mentioned history files is needed for analyzing the cause of a fault or referring to the operation history, these data are read out from the hard disk preserving each history file to use.

Now, in regard to the aforementioned processing of the conventional system, there are problems in respect of information distribution on occurrence of alarm condition and package housing change in transmission apparatus 2, and a fault condition in supervision and control operation system 1. Such problems are described below:

(a) In the above-mentioned processing (1), the occurrence of the alarm can be recognized only on the screen of the terminal activated by supervision and control operation system 1, remote supervision and control terminal 3, or network supervision terminal 4.

On occurrence of a serious alarm which possibly impedes the network operation, this occurrence can only be recognized by a maintenance staff supervising the network operation in front of the above-mentioned terminal. In the event of a serious alarm, it is necessary for the maintenance staff to inform the related section of the situation one after another. Such a method causes a problem of consuming substantial time before the related whole sections come to recognize the situation.

Despite a serious alarm on the network or apparatus fault, the necessary action is delayed, which may greatly trouble to the network users.

Unless an application program is introduced into remote supervision terminal 3 or network supervision terminal 4, there is no way to supervise such a serious alarm. Here, even if there is a section which is responsible for supervising particular serious alarms only, this section is required to obtain the above-mentioned application program, which becomes costly. (b) Also, in the case of the aforementioned processing (2), similar to the above-mentioned issue (a), the package housing change in transmission apparatus 2 can only be confirmed by the screens of GUI terminal 10 of supervision and control operation system 1 or GUI terminal 30 of remote supervision and control terminal 3.

In the case that transmission apparatus 2 is installed at the place having neither the screen of either GUI terminal 10 of supervision and control operation system 1 nor the screed of GUI terminal 30 of remote supervision and control terminal 3, there may be a case that the maintenance staff working on package insertion/deletion cannot confirm the validity of operation on the site.

Unless an application program is introduced into remote supervision terminal 3, there is no means to confirm the properness of the package housing change. Here, even if there is a section which is responsible for package housing operation only, this section is required to obtain the above-mentioned application program commonly used for the entire sections, which becomes costly.

(c) In the above-mentioned processing (3), in order to detect fault occurrence in supervision and control operation system 1 in real time, a maintenance staff is required for continuously supervising the screen of GUI terminal 10 of supervision and control operation system 1. For another detection method, when the control from remote supervision and control terminal 3 becomes unable to execute, fault occurrence can be detected for the first time. As a survey means of fault cause in such cases, the maintenance staff collects a software fault information file accumulated in the hard disk or the external storage of supervision and control operation system 1 to forward to a staff in charge of analysis. Accordingly there arises a problem that substantially long time is needed until the survey and analysis is performed.

In general, the staff in charge of analysis belongs to a particular section, while maintenance staff are deployed in every sections where the OpS is introduced. The staff in charge of analysis may sometimes request to obtain necessary fault information file for surveying. Also in some cases it takes a long time for the survey.

(d) In the aforementioned processing (4), the staff in charge of analysis may need to obtain a DB backup information file through the maintenance staff when a fault occurs in supervision and control operation system 1. This may also consumes a long time until the survey and analysis begins, similar to the aforementioned processing (3).

Further, there may be a case that, because the preserved backup file has a finite capacity, the required DB backup file has already been deleted although past data restoration is necessary, making the fault cause analysis impossible.

(e) Also, in the aforementioned processing (5), in the event of the fault in supervision and control operation system 1, a problem arises that it requires a long time before starting survey and analysis because the staff in charge of analysis has to obtain each history file through the maintenance staff.

Moreover, there is a case of unsuccessful investigation of the cause because of the limitation of date to be traced back when using the history preservation method in the processing (2).

As explained in above (a) to (e), according to the prior arts, there exists problems that a serious alarm occurring on the network can be recognized in real time by a limited number of maintenance staff, and that the information related to a package housing change cannot be known by a maintenance staff actually operating in front of the transmission apparatus. One solution for these problems is to introduce the application program for remote supervision and control terminal 3 and network supervision terminal 4. However, this method produces another problem of large cost increase.

In addition, when a fault occurs in supervision and control operation system 1, it requires a long time before a staff in charge of analysis obtains entire information needed for the survey. DB backup information and history information are stored in a hard disk or an external storage of a terminal activated by supervision and control operation system 1. Because of a finite capacity of such apparatus, the staff in charge of analysis does not always obtain the entire information necessary for analyzing the fault, which also causes another problem.

### SUMMARY OF THE INVENTION

Accordingly, the present invention aims to solve the aforementioned problems (a) to (e). As a first embodiment of the transmission network system according to the present invention, in a transmission network system having a plurality of transmission apparatus and a supervision and control operation system being connected to a network, the above-mentioned supervision and control operation system is provided with a means for transmitting the information related to a network alarm detected by the transmission apparatus to a predetermined mail address via an electronic mail.

As a second embodiment of the transmission network system to solve the above-mentioned problem, in a transmission network system having a plurality of transmission apparatus and a supervision and control operation system being connected to a network, the supervision and control operation system is provided with a means for transmitting the information related to a package housing change detected by the transmission apparatus to a predetermined mail address via an electronic mail.

As a third embodiment of the transmission network system to solve the above-mentioned problem, in a transmission network system having a plurality of transmission apparatus and a supervision and control operation system being connected to a network, the supervision and control operation system is provided with a means for transmitting software fault information detected by the supervision and control operation system to a predetermined mail address via an electronic mail.

As a fourth embodiment of the transmission network system, in a transmission network system having a plurality of transmission apparatus and a supervision and control operation system being connected to a network, the supervision and control operation system is provided with a means for transmitting the database backup information of the supervision and control operation system which is collected automatically and periodically to a predetermined mail address via an electronic mail.

As a fifth embodiment of the transmission network system, in a transmission network system having a plurality of transmission apparatus and a supervision and control operation system being connected to a network, the supervision and control operation system is provided with a means for recording operation information executed from a control terminal and the transmission apparatus to the supervision and control operation system, and a means for transmitting an operation history recorded by the recording means to a predetermined mail address via an electronic mail.

As a sixth embodiment of the transmission network system, in a transmission network system having a plurality of transmission apparatus and a supervision and control operation system being connected to a network, the supervision and control operation system is provided with a means for recording communication information related to command transmission and reception and event transmission and reception performed between the supervision and control operation system and a control terminal or the transmission apparatus, and a means for transmitting a communication history recorded by the recording means to a predetermined mail address via an electronic mail.

As a seventh embodiment of the transmission network system, in the aforementioned first embodiment, the predetermined mail address is selected according to the time zone when the network alarm is issued.

As an eighth embodiment of the transmission network system, in either of the aforementioned first to sixth embodiments, the information to be transmitted by the transmission means via the electronic mail is transmitted either in the form of a mail text or an attached file.

As a ninth embodiment of the transmission network system, in either of the first to sixth embodiments, alarm sound is produced at a terminal corresponding to the destination mail address when the transmitted information is a predetermined serious alarm.

As a tenth embodiment of the transmission network system, in either of the first to sixth embodiments, a means is provided for storing database backup information of the supervision and control operation system into an external storage medium in an external storage of a terminal corresponding to the destination mail address when the transmitted information is a predetermined serious alarm.

Further scopes and features of the present invention will become more apparent by the following description of the embodiments with the accompanied drawings.

### BRIEF DESCRIPTION OF THE DRAWINGS

FIG. 1 shows a conventional configuration example of a transmission apparatus and a supervision and control operation system.

FIG. 2 shows a fault notification information flow on a network incorporating the fault notification method according to the present invention into the supervision and control operation system.

FIG. 3 shows a configuration example of a supervision and control operation system 1 incorporating the method of the present invention.

FIG. 4 shows a configuration of a mail transmission information management table 16 which is input into a supervision and control program unit 11 and a mail transmission management program unit 14 in the configuration shown in FIG. 3.

FIG. 5 shows a transmission address book for network alarm.

FIG. 6 shows a transmission address book for apparatus fault alarm.

FIG. 7 shows a transmission address book for package housing information.

FIG. 8 shows a transmission address book for software fault information.

FIG. 9 shows a transmission address book for DB backup information.

FIG. 10 shows a transmission address book for operation history.

FIG. 11 shows a transmission address book for communication history.

FIG. 12 shows an embodiment of a network alarm file.

FIG. 13 shows an embodiment of an apparatus fault alarm file.

FIG. 14 shows an embodiment of a package housing information file.

FIG. 15 shows an embodiment of a software fault information file.

FIG. 16 shows an embodiment of a DB backup information file.

FIG. 17 shows an embodiment of an operation history file.

FIG. 18 shows an embodiment of a communication history file.

FIG. 19 shows a processing procedure at the initial start of supervision and control program unit 11.

FIG. 20 shows a processing procedure at the initial start of mail transmission management program unit 14.

FIG. 21 shows a processing procedure at the initial start of a mail transmission program unit 15.

FIG. 22 shows a processing procedure from when a network alarm sent from a transmission apparatus to when a network alarm file 20 is generated or updated.

FIG. 23 shows a processing procedure from when an apparatus fault alarm is sent from transmission apparatus 2 to when an apparatus fault alarm file 21 is generated or updated.

FIG. 24 shows a processing procedure from when package housing change information is sent from transmission apparatus 2 to when a package housing information file 22 is generated or updated.

FIG. 25 shows a processing procedure from when supervision and control operation system 1 detects a software fault in the terminal connected thereto to when a software fault information file 23 is generated or updated.

FIG. 26 shows a processing procedure from when supervision and control operation system 1 starts automatic DB backup processing to when a DB backup information file 24 is generated or updated.

FIG. 27 shows a processing procedure from when control from remote supervision and control terminal 3 is started to when an operation history file 25 is generated or updated.

FIG. 28 shows a processing procedure from when control from remote supervision and control terminal 3 is started to when a communication history file 26 is generated or updated.

FIG. 29 shows a processing procedure up to when a mail transmission request is issued to mail transmission program unit 15 (part 1).

FIG. 30 shows a processing procedure up to when a mail transmission request is issued to mail transmission program unit 15 (part 2).

FIG. 31 shows a processing procedure up to when a mail transmission request is issued to mail transmission program unit 15 (part 3).

FIG. 32 shows a processing procedure up to when a mail transmission request is issued to mail transmission program unit 15.

FIG. 33 shows a processing procedure from when receiving the mail transmission request of network alarm file 20 to when mail transmission is carried out.

FIG. 34 shows a processing procedure up to when the mail transmission of an apparatus fault alarm file 21 is carried out.

FIG. 35 shows a processing procedure up to when the mail transmission of package housing information file 22 is carried out.

FIG. 36 shows a processing procedure up to when the mail transmission of software fault information file 23 is carried out.

FIG. 37 shows a processing procedure up to when the mail transmission of DB backup information file 24 is carried out.

FIG. 38 shows a processing procedure up to when the mail transmission of operation history file 25 is carried out.

FIG. 39 shows a processing procedure up to when the mail transmission of communication history file 26 is carried out.

FIG. 40 shows a flow of command execution for emergency measure in the event of a serious fault.

FIG. 41 shows an embodiment of a program configuration when executing commands for emergency measures.

FIG. 42 shows an exemplary command description format for use in an electronic mail (for reply) when executing processing for each emergency measure.

FIG. 43 shows a processing procedure from when receiving the command for emergency measure to when requesting supervision and control program unit 11 to execute processing.

FIG. 44 shows a processing procedure up to when the command for emergency measure is actually executed after initiated by a mail reception program unit 150.

### DETAILED DESCRIPTION OF THE PREFERRED EMBODIMENTS

The preferred embodiments of the present invention are described hereinafter referring to the charts and drawings.

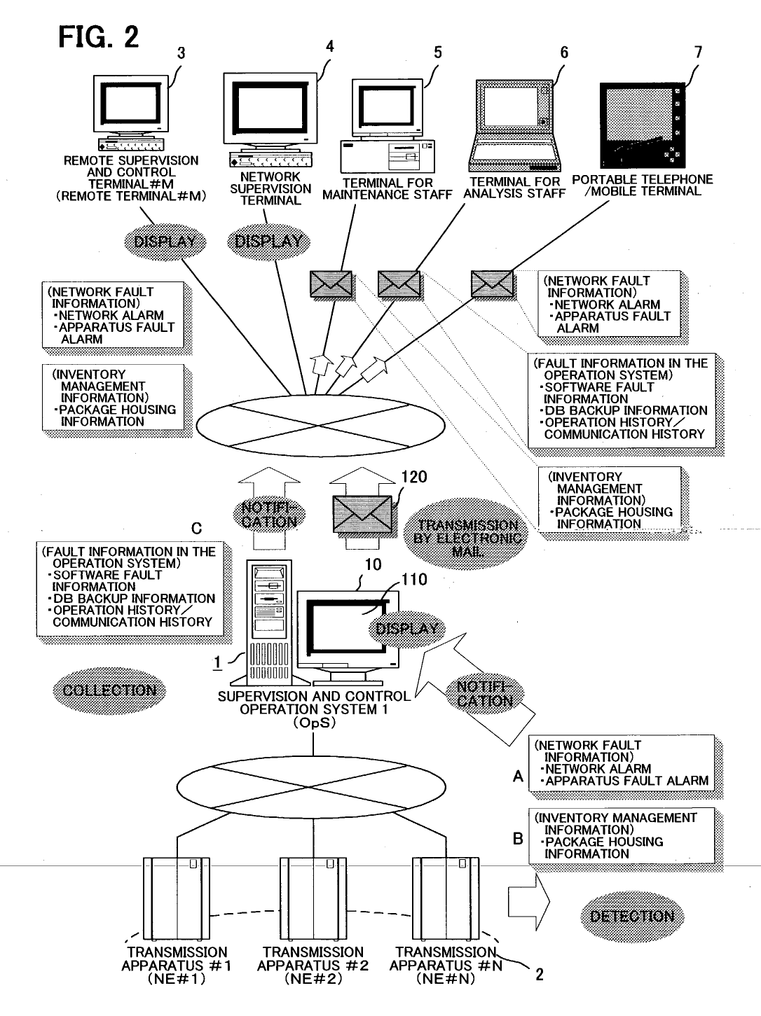

FIG. 2 shows a flow of fault notification information on a network in which the fault notification method for use in the operation system according to the present invention is applied. Such information includes an alarm, package housing change or fault information and fault notification information necessary for analysis and survey in the event of fault.

Here, more specifically, fault notification information included in the object of the present invention means a network alarm generated in the network constituted of the aforementioned plurality of transmission apparatus 2, apparatus fault alarm generated in transmission apparatus 2, and fault information which occurs in supervision and control operation system (OpS) 1.

In addition, backup information and history information necessary for identifying the cause of a fault are also included in the object of the present invention.

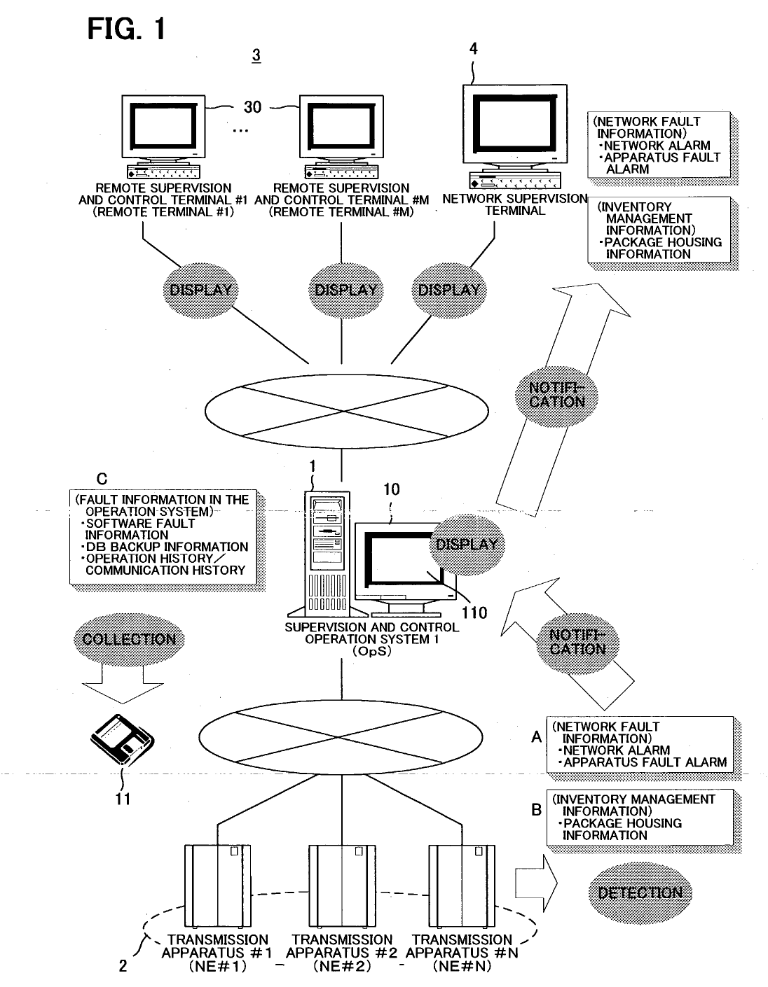

As shown in FIG. 2, the feature of the present invention lies in information distribution via electronic mail 120 on any of the aforementioned information, in addition to the fault notification method of the prior art shown in FIG. 1. Therefore like numerals and symbols are attached to refer to like parts shown in FIG. 1.

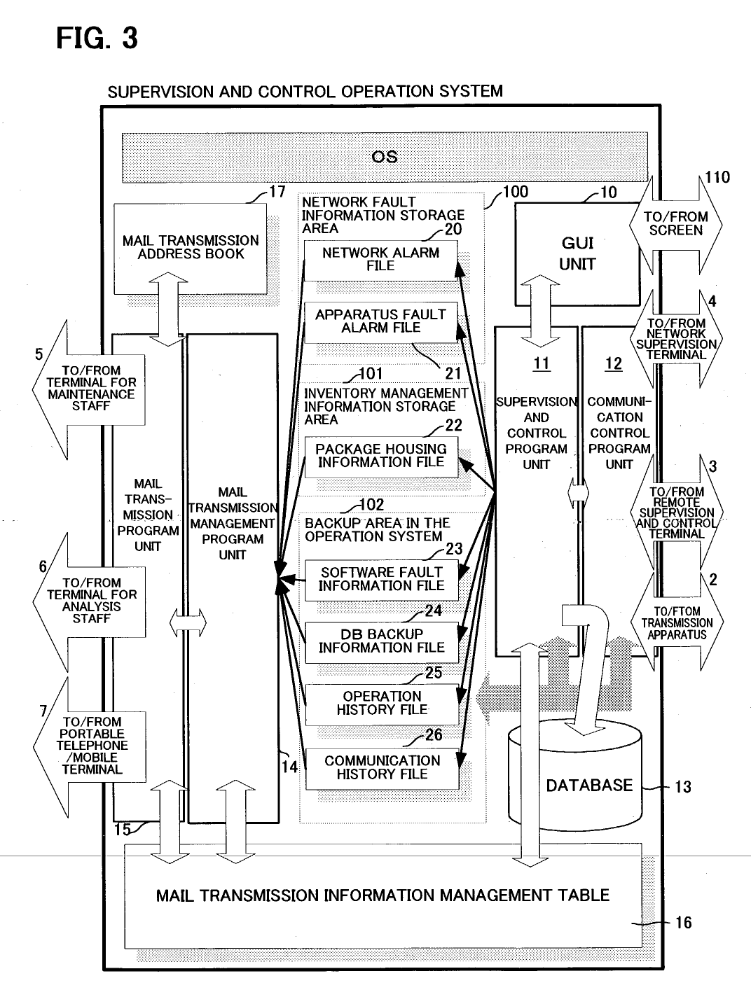

A configuration example of supervision and control operation system 1 incorporating the method of the present invention is shown in FIG. 3. As major elements of supervision and control operation system 1, GUI unit 10, supervision and control program unit 11, communication control program unit 12 and database 13 are similar to those provided in supervision and control operation system 1 of the conventional network shown in FIG. 1.

According to the present invention, supervision and control operation system 1 is further constituted of a mail transmission management program unit 14 for performing electronic mail transmission management against each of the above-mentioned information, a mail transmission program unit 15 for performing transmission by an electronic mail, a mail transmission information management table 16 for managing data for electronic mail transmission, and a mail transmission address book 17 for managing electronic mail addressees.

In supervision and control operation system 1 having the above configuration, the problems in the prior art is to be solved by distributing the information via electronic mail 120.

An operation of the present invention shown in FIG. 2 is described below referring to FIG. 3.

(I) When supervision and control program unit 11 of supervision and control operation system 1 detects a serious alarm, this supervision and control program unit 11 generates a network alarm file 20, or apparatus fault alarm file 21, including the fault point, the alarm type and the fault occurrence time to store into an alarm file folder in a network fault information storage area 100 designated by mail transmission information management table 16.

Mail transmission management program unit 14 periodically looks in the above-mentioned folder at predetermined intervals specified in mail transmission information management table 16. When alarm files 20, 21 exist, mail transmission management program unit 14 transmits an electronic mail 120 to which the related file is attached to an address specified in mail transmission address book 17 via mail transmission program unit 15.

Further, mail transmission management program unit 14 transmits mails for a plurality of times the text of which includes information described in the above-mentioned alarm files 20, 21 divided into several pieces of information according to the limit in number of characters specified in mail transmission information management table 16.

Through the operation described above, it becomes possible to recognize the occurrence of an alarm through a PC terminal 5 for maintenance staff or a PC terminal 6 for staff in charge of analysis where supervision and control operation system 1 or remote supervision and control terminal 3 are not activated, or even through a portable telephone terminal/mobile terminal 7.

Also, in regard to the types of alarm to be output, it is possible to filter in supervision and control operation system 1, to transmit only a mail having an alarm which is defined as serious.

This enables to reduce the time required for information transfer, which has been a problem in the prior art. Moreover, for the section of which mission is to supervise serious alarms only, the supervision can be performed if there is a PC terminal or a portable telephone in which the software having an electronic mail reception means is incorporated.

(II) When supervision and control program unit 11 of supervision and control operation system 1 detects package housing change, this supervision and control program unit 11 generates a package housing information file 22, in which point of occurrence, package of interest and time of occurrence are described, to store into a folder in an inventory information management area 101 designated by mail transmission information management table 16.

Mail transmission management program unit 14 periodically looks in the above-mentioned folder at predetermined intervals specified in mail transmission information management table 16. When package housing information file 22 exists, mail transmission management program unit 14 transmits an electronic mail to which the file is attached to an address specified in mail transmission address book 17 via mail transmission program unit 15.

Further, mail transmission management program unit 14 transmits mails for a plurality of times the text of which includes information described in the above-mentioned package housing information file 22 divided into several pieces of information according to the limit in number of characters specified in mail transmission information management table 16.

Through the operation described above, it becomes possible to recognize the occurrence of package housing change through a PC terminal 5 for maintenance staff or a PC terminal 6 for staff in charge of analysis where supervision and control operation system 1 or remote supervision and control terminal 3 are not activated, or even through a portable telephone/mobile terminal 7.

This enables to reduce the time required for information transfer, which has been a problem in the prior art. Moreover, for the section of which job is to supervise package housing change only, the supervision can be performed if there is a PC terminal or a portable telephone in which the software having an electronic mail reception means is incorporated.

(III) When supervision and control program unit 11 in supervision and control operation system 1 detects software fault, this supervision and control program unit 11 generates a software fault information file 23 including the fault point, the event having occurred and the fault occurrence time, to store into a folder in a backup area 102 of the operation system specified in mail transmission information management table 16.

Mail transmission management program unit 14 periodically looks in the above-mentioned folder at predetermined intervals specified in mail transmission information management table 16. When software fault file 23 exists, mail transmission management program unit 14 transmits an electronic mail 120 to which the file concerned is attached to an address specified in mail transmission address book 17 via mail transmission program unit 15.

Through the operation described above, it becomes possible for staff in charge of analysis to recognize the occurrence of software fault in supervision and control operation system 1 at the same time as recognized by a maintenance staff. Also, by the software fault information file attached to the received electronic mail 120, the maintenance staff or the staff in charge of analysis can instantly recognize the information on the software fault currently occurring.

Here, by executing at the same time a similar operation as the operations (IV), (V) described later, a DB backup information file 24, an operation history file 25 and a communication history file 26 necessary for fault analysis are also transmitted.

Thus the staff in charge of analysis can obtain entire information necessary for analysis at the time when the software fault occurrence is recognized. Accordingly, the survey and analysis work can be started instantly, which results in reduction of restoration time from the fault.

(IV) When supervision and control program unit 11 in supervision and control operation system 1 completes the DB backup processing which is executed automatically and periodically, this supervision and control program unit 11 stores DB backup information file 24 generated by the above-mentioned processing into a folder in a backup area 102 in the operation system designated by mail transmission information management table 16.

Mail transmission management program unit 14 periodically looks in the above-mentioned folder at predetermined intervals specified in mail transmission information management table 16. When DB backup information file 24 exists, mail transmission management program unit 14 transmits an electronic mail 120 to which DB backup information file 24 is attached to an address specified in mail transmission address book 17 via mail transmission program unit 15.

Through the operation described above, the DB backup information is periodically transmitted to the maintenance staff or the staff in charge of analysis. This can circumvent the conventional problem of losing old DB backup information file 24 necessary for fault analysis caused by a storage capacity limit for preservation.

(V) When supervision and control program unit 11 in supervision and control operation system 1 executes control to transmission apparatus 2 under the control of either the own GUI unit 10 or remote supervision and control terminal 3, this supervision and control program unit 11 generates operation history file 25 to store into a folder designated by mail transmission information management table 16.

Mail transmission management program unit 14 periodically looks in the above-mentioned folder at predetermined intervals specified in mail transmission information management table 16. When operation history file 25 exists, mail transmission management program unit 14 transmits an electronic mail 120 to which operation history file 25 is attached to an address specified in mail transmission address book 17 via mail transmission program unit 15.

Through the operation described above, the operation history information is periodically transmitted to the maintenance staff or the staff in charge of analysis. This can circumvent the conventional problem of losing old operation history file 25 necessary for fault analysis caused by the capacity limit of the storage for preservation.

Similarly, communication history file 26 recorded by communication control program unit 12 of supervision and control operation system 1 is periodically transmitted to the maintenance staff or the staff in charge of analysis.

As mentioned above, in the program and data configuration of supervision and control operation system 1 shown in FIG. 3, supervision and control program unit 11 performs to generate and update the mail transmission information. Mail transmission management program unit 14 detects the mail transmission information, to transmit the electronic mail through mail transmission management program unit 14.

Now, hereinafter the details of data structure and processing procedure necessary for the aforementioned operation are described.

First, a table configuration required for implementing the method according to the present invention is described.

[Mail Transmission Information Management Table 16]

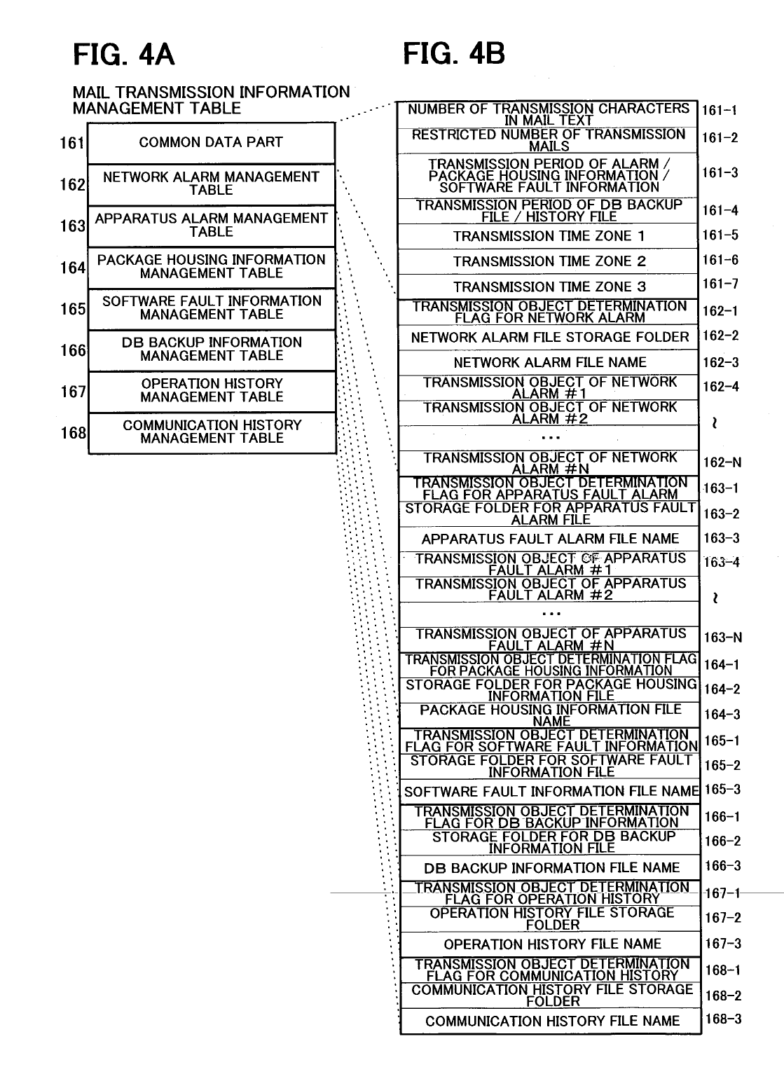

FIG. 4 shows a structure of a mail transmission information management table 16 which is input into supervision and control program unit 11 and mail transmission management program unit 14 in the configuration shown in FIG. 3.

Each configuration element of a plurality of sub-tables 161-168 constituting of mail transmission information management table 16 shown in FIG. 4 is explained in the following referring to FIG. 4B.

Common Data Unit 161

Number of transmission characters in mail text [161-1]: When information is transmitted through an electronic mail, it may not be possible to open a file attached to the electronic mail in the case that a portable telephone or a mobile terminal is used as a reception terminal. In such a case divided contents of the attached file have to be described in each text of a plurality of electronic mails for transmission.

Accordingly, considering the case of transmitting the contents of the attached file to be contained in mail text, the maximum number of characters per mail is defined here.

Restricted number of transmission mails [161-2]: When a fault of large scale occurs, the mount of information to be transmitted becomes large. In such a case, if the information is described in the texts of a plurality of electronic mails to transmit, there may possibly arise a case that the entire mails cannot be received because of the limited number of mails on the reception side using a portable telephone or a mobile terminal. For this reason, the maximum number of electronic mails transmitted in succession is defined here.

Transmission period of alarm/housing information/software fault information [161-3]: The period for performing the detection processing of the following files to be transmitted is defined: network alarm file, apparatus fault alarm file, package housing information file, and software fault information file. As for such information, it is necessary to detect and inform at short periods. By defining a short period here, it becomes possible to transmit the information almost in real time.

Transmission period of DB backup file/history file [161-4]: The period for performing detection processing of DB backup file, operation history file and communication history file to be transmitted is defined here.

Transmission time zone 1 [161-5], transmission time zone 2 [161-6], and transmission time zone 3 [161-7]: As for transmission of network alarm file, apparatus fault alarm file, package housing information file, and software fault information file, where information notification in real time is necessary, it is required to determine mail addressee differently depending on the time zone in which the fault is detected. Here, the mail transmission time zone is divided into three time zones, defining transmission time zones as transmission time zone 1, transmission time zone 2, and transmission time zone 3. Although the time zones in this embodiment consist of three time zones, it is also possible to subdivide into more time zones when necessary.

Network Alarm Management Table 162

Transmission object determination flag for network alarm [162-1]: A flag is defined for determining whether information related to network alarm is to be transmitted via a mail.

Network alarm file storage folder [162-2]: A folder for generating a network alarm file is defined.

Network alarm file name [162-3]: A file name for use when generating the network alarm file is defined.

Transmission object of network alarm #1-#N [162-4 to 162-N]: A network alarm of an object of mail transmission is defined.

Apparatus Alarm Management Table 163

Transmission object determination flag for apparatus fault alarm [163-1]: A flag is defined for determining whether the information related to apparatus fault alarm is to be transmission via a mail.

Storage folder for apparatus fault alarm file [163-2]: A folder for generating an apparatus fault alarm file is defined.

Apparatus fault alarm file name [163-3]: A file name for use when generating the apparatus fault alarm file is defined.

Transmission object of apparatus fault alarm #1-#N [163-4 to 163-N]: An apparatus fault alarm as an object of mail transmission is defined.

Package Housing Information Management Table 164

Transmission object determination flag for package housing information [164-1]: A flag is defined for determining whether the package housing information is to be transmission via a mail.

Storage folder for package housing information file [164-2]: A folder for generating a package housing information file is defined.

Package housing information file name [164-3]: A file name for use when generating the package housing information file is defined.

Software Fault Information Management Table 165

Transmission object determination flag for software fault information [165-1]: A flag is defined for determining whether the software fault information is to be transmission via a mail.

Storage folder for software fault information file [165-2]: A folder for generating a software fault information file is defined.

Software fault information file name [165-3]: A file name for use when generating the software fault information file is defined.

DB Backup Information Management Table 166

Transmission object determination flag for DB backup information [166-1]: A flag is defined for determining whether the DB backup information is to be transmission via a mail.

Storage folder for DB backup information file [166-2]: A folder for generating a DB backup information file is defined.

DB backup information file name [166-3]: A file name for use when generating the DB backup information file is defined.

Operation History Management Table 167

Transmission object determination flag for operation history [167-1]: A flag is defined for determining whether an operation history is to be transmission via a mail.

Operation history file storage folder [167-2]: A folder for generating an operation history file is defined.

Operation history file name [167-3]: A file name for use when generating the operation history file is defined.

Communication History Management Table 168

Transmission object determination flag for communication history [168-1]: A flag is defined for determining whether a communication history is to be transmission via a mail.

Communication history file storage folder [168-2]: A folder for generating a communication history file is defined.

Communication history file name [168-3]: A file name for use when generating the communication history file is defined.

[Mail Transmission Address Book 17]

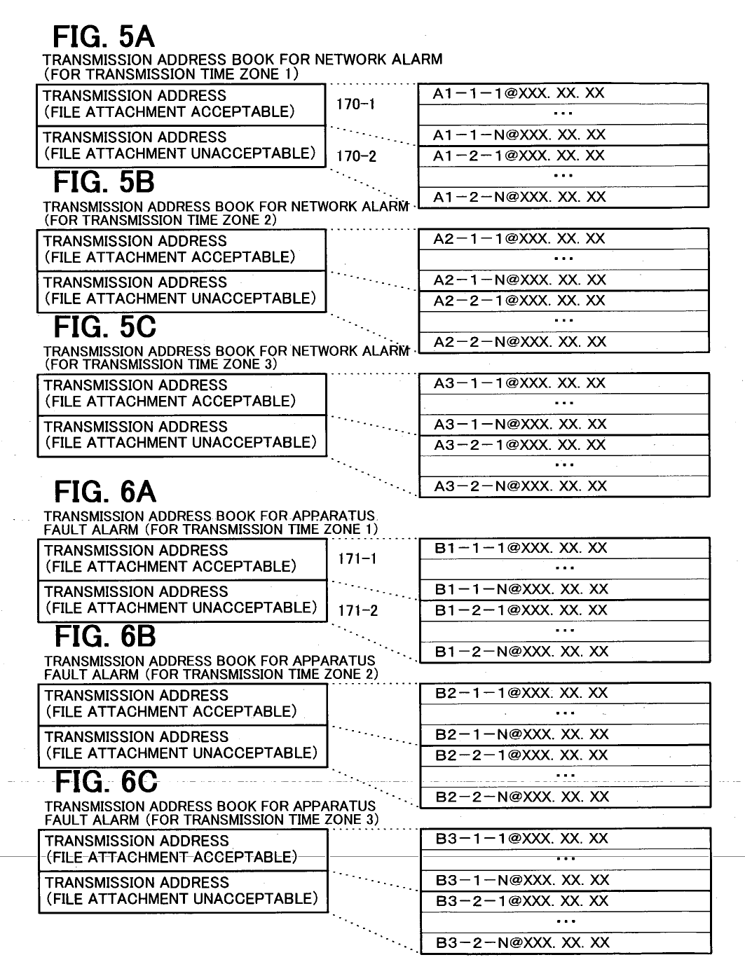

In the configuration shown in FIG. 3, mail transmission address book 17 which is input into mail transmission program unit 15 is illustrated in FIGS. 5-11. Each address constituting mail transmission address book 17 shown in FIG. 3 and the configuration element thereof are described below:

Transmission Address Book For Network Alarm (for Transmission Time Zone 1): FIG. 5A

This address book is made effective when a mail transmission time related to a network alarm corresponds to [transmission time in transmission time zone 1] in mail transmission information management table 16.

Transmission address (file attachment acceptable) [170-1]: A mail address to which a network alarm file is transmitted as an attached file is defined. A plurality of addresses, “A1-1-1@XXX.XX.XX” to “A1-1-N@XXX.XX.XX”, may be defined.

Transmission address (file attachment unacceptable) [170-2]: A mail address to which a network alarm file is transmitted as a text in a mail is defined. A plurality of addresses, “A1-2-1@XXX.XX.XX” to “A1-2-N@XXX.XX.XX”, may be defined.

Transmission Address Book for Network Alarm (for Transmission Time Zone 2): FIG. 5B

This address book is made effective when a mail transmission time related to a network alarm corresponds to [transmission time in transmission time zone 2] in mail transmission information management table 16. The structure of the address book is similar to [transmission address book for network alarm (for transmission time zone 1): FIG. 5A]

Transmission Address Book for Network Alarm (for Transmission Time Zone 3): FIG. 5C

This address book is made effective when a mail transmission time related to a network alarm corresponds to [transmission time in transmission time zone 3] in mail transmission information management table 16. The structure of the address book is similar to [transmission address book for network alarm (for transmission time zone 1): FIG. 5A].

Transmission Address Book for Apparatus Fault Alarm (for Transmission Time Zone 1): FIG. 6A

This address book is made effective when a mail transmission time related to an apparatus fault alarm corresponds to [transmission time in transmission time zone 1] in mail transmission information management table 16.

Transmission address (file attachment acceptable) [171-1]: A mail address to which an apparatus fault alarm file is transmitted as an attached file is defined.

A plurality of addresses, “B1-1-1@XXX.XX.XX” to “B1-1-N@XXX.XX.XX”, may be defined.

Transmission address (file attachment unacceptable) [171-2]: A mail address to which an apparatus fault alarm file is transmitted as a text in a mail is defined. A plurality of addresses may be defined.

Namely, a plurality of addresses, “B1-2-1@XXX.XX.XX” to “B1-2-N@XXX.XX.XX”, may be defined.

Transmission Address Book for Apparatus Fault Alarm (for Transmission Time Zone 2): FIG. 6B

This address book is made effective when a mail transmission time related to an apparatus fault alarm corresponds to [transmission time in transmission time zone 2] in mail transmission information management table 16. The structure of the address book is similar to [transmission address book for apparatus fault alarm (for transmission time zone 1)].

Transmission Address Book for Apparatus Fault Alarm (for Transmission Time Zone 3): FIG. 6C

This address book is made effective when a mail transmission time related to an apparatus fault alarm corresponds to [transmission time in transmission time zone 3] in mail transmission information management table 16. The structure of the address book is similar to [transmission address book for apparatus fault alarm (for transmission time zone 1)].

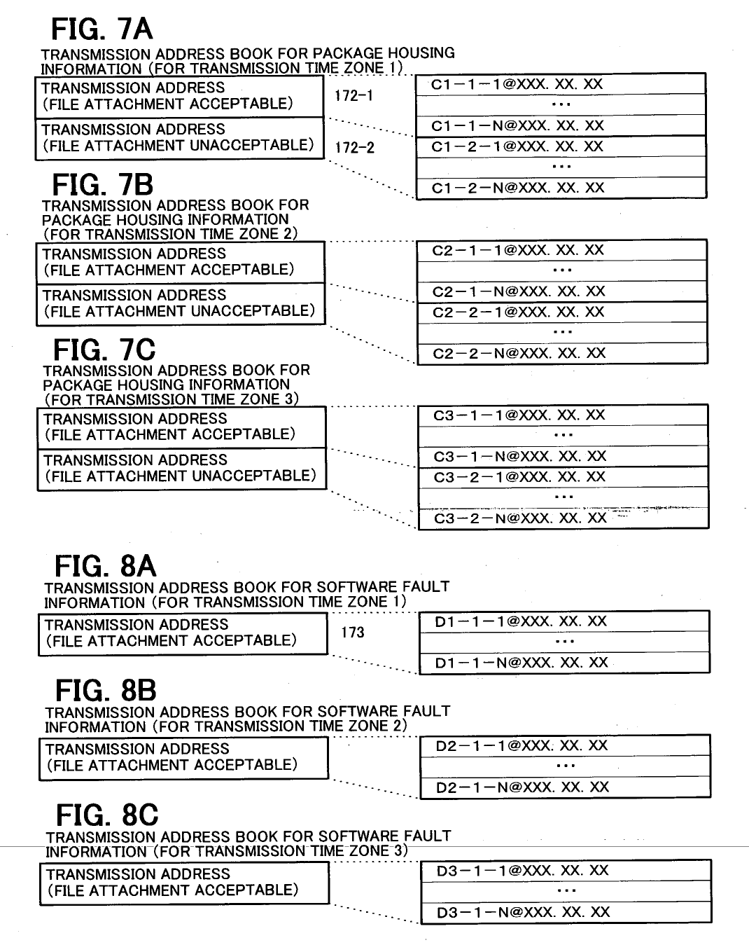

Transmission Address Book for Package Housing Information (for Transmission Time Zone 1): FIG. 7A

This address book is made effective when a mail transmission time related to package housing information corresponds to [transmission time in transmission time zone 1] in mail transmission information management table 16.

Transmission address (file attachment acceptable) [172-1]: A mail address to which a package housing information file is transmitted as an attached file is defined.

A plurality of addresses, “C1-1-1@XXX.XX.XX” to “C1-1-N@XXX.XX.XX”, may be defined.

Transmission address (file attachment unacceptable) [172-2]: A mail address to which a network alarm file is transmitted as a text in a mail is defined. A plurality of addresses may be defined.

Namely, a plurality of addresses, “A1-2-1@XXX.XX.XX” to “A1-2-N@XXX.XX.XX”, may be defined.

Transmission Address Book for Package Housing Information (for Transmission Time Zone 2): FIG. 7B

This address book is made effective when a mail transmission time related to package housing information corresponds to [transmission time in transmission time zone 2] in mail transmission information management table 16. The structure of the address book is similar to [transmission address book for package housing information (for transmission time zone 1): FIG. 7A]

Transmission Address Book for Package Housing Information (for Transmission Time Zone 3): FIG. 7C

This address book is made effective when a mail transmission time related to package housing information corresponds to [transmission time in transmission time zone 3] in mail transmission information management table 16. The structure of the address book is similar to [transmission address book for package housing information (for transmission time zone 1): FIG. 7A]

Transmission Address Book for Software Fault Information (for Transmission Time Zone 1): FIG. 8A

This address book is made effective when a mail transmission time related to software fault information corresponds to [transmission time in transmission time zone 1] in mail transmission information management table 16.

Transmission address (file attachment acceptable) [173]: A mail address to which a software fault information file is transmitted as an attached file is defined.

A plurality of addresses, “D1-1-1@XXX.XX.XX” to “D1-1-N@XXX.XX.XX”, may be defined.

Transmission Address Book for Software Fault Information (for Transmission Time Zone 2): FIG. 8B

This address book is made effective when a mail transmission time related to software fault information corresponds to [transmission time in transmission time zone 2] in mail transmission information management table 16. The structure of the address book is similar to [transmission address book for software fault information (for transmission time zone 1): FIG. 8A].

Transmission Address Book for Software Fault Information (for Transmission Time Zone 3): FIG. 8C

This address book is made effective when a mail transmission time related to software fault information corresponds to [transmission time in transmission time zone 3] in mail transmission information management table 16. The structure of the address book is similar to [transmission address book for software fault information (for transmission time zone 1): FIG. 8A].

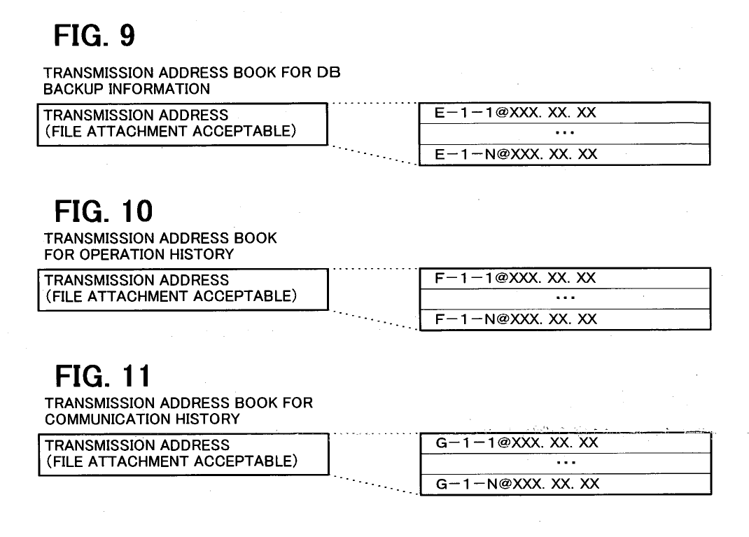

Transmission Address Book for DB Backup Information: FIG. 9

A mail address to which DB backup information is transmitted as an attached file is defined. A plurality of addresses, “E1-1-1@XXX.XX.XX” to “E1-1-N@XXX.XX.XX”, may be defined.

Transmission Address Book For Operation History: FIG. 10

A mail address to which an operation history is transmitted as an attached file is defined. A plurality of addresses, “F1-1-1@XXX.XX.XX” to “F1-1-N@XXX.XX.XX”, may be defined.

Transmission Address Book for Communication History: FIG. 10

A mail address to which a communication history is transmitted as an attached file is defined. A plurality of addresses, “G1-1-1@XXX.XX.XX” to “G1-1-N@XXX.XX.XX”, may be defined.

Now, examples of description information in each file to be transmitted by mail are shown hereinafter.

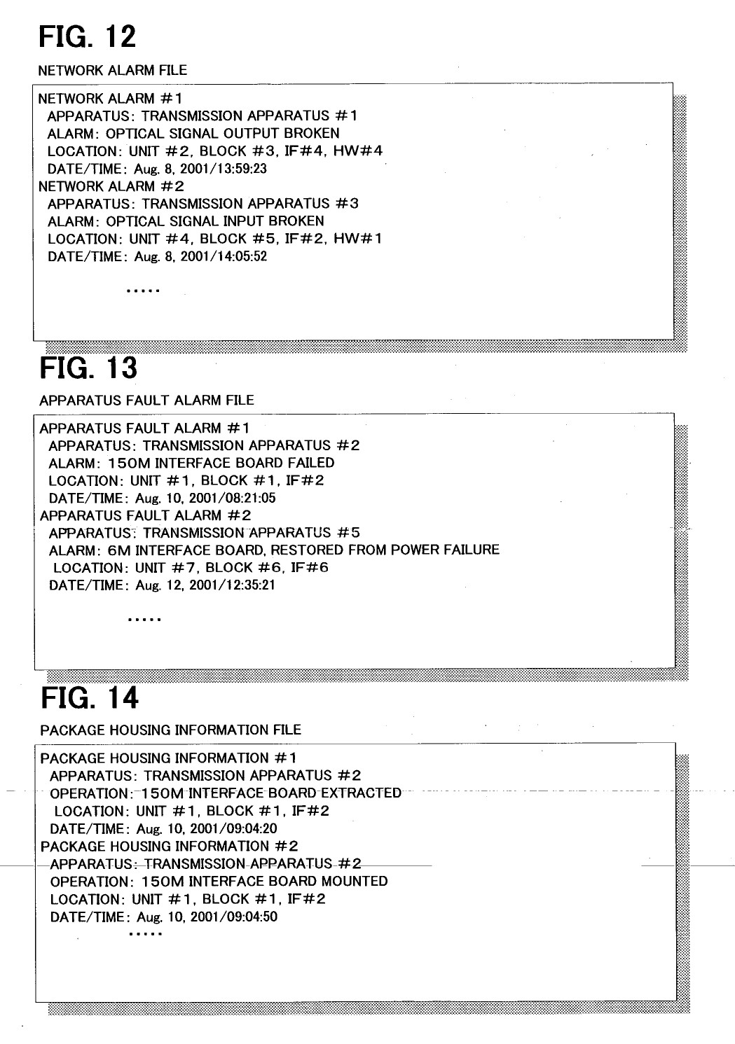

In the configuration shown in FIG. 3, configuration examples of the following files to be transmitted by mail are shown in FIGS. 12-18: Network alarm file 20, apparatus fault alarm file 21, package housing information file 22, software fault information file 23, DB backup information file 24, operation history file 25, and communication history file 26.

The description information of network alarm file 20 shown in FIG. 12 includes “apparatus (the apparatus in which the alarm is produced)”, “alarm (the type of alarm produced)”, “location (detailed location in the apparatus where the alarm is produced)” and “date/time (when the alarm is produced)”.

A maintenance staff, when receiving network alarm file 20, can recognize what sort of network alarm has occurred by referring to the description information included in this file.

Similarly, the description information of apparatus fault alarm file 21 shown in FIG. 13 includes “apparatus (the apparatus in which the alarm is produced)”, “alarm (the type of alarm produced)”, “location (detailed location in the apparatus where the alarm is produced)” and “date/time (when the alarm occurs)”.

A maintenance staff receiving apparatus fault alarm file 21 can recognize what sort of apparatus fault alarm has occurred by referring to the description information included in this file.

Also, the description information in package housing information file 22 shown in FIG. 14 includes “apparatus (the apparatus in which the package housing change is produced)”, “operation (the contents of package housing change performed)”, “location (detailed location in the apparatus where the package housing change performed)” and “date/time (when the package housing change occurs)”.

The maintenance staff receiving package housing information file 22 can recognize what sort of package housing change has occurred by referring to the description information included in this file.

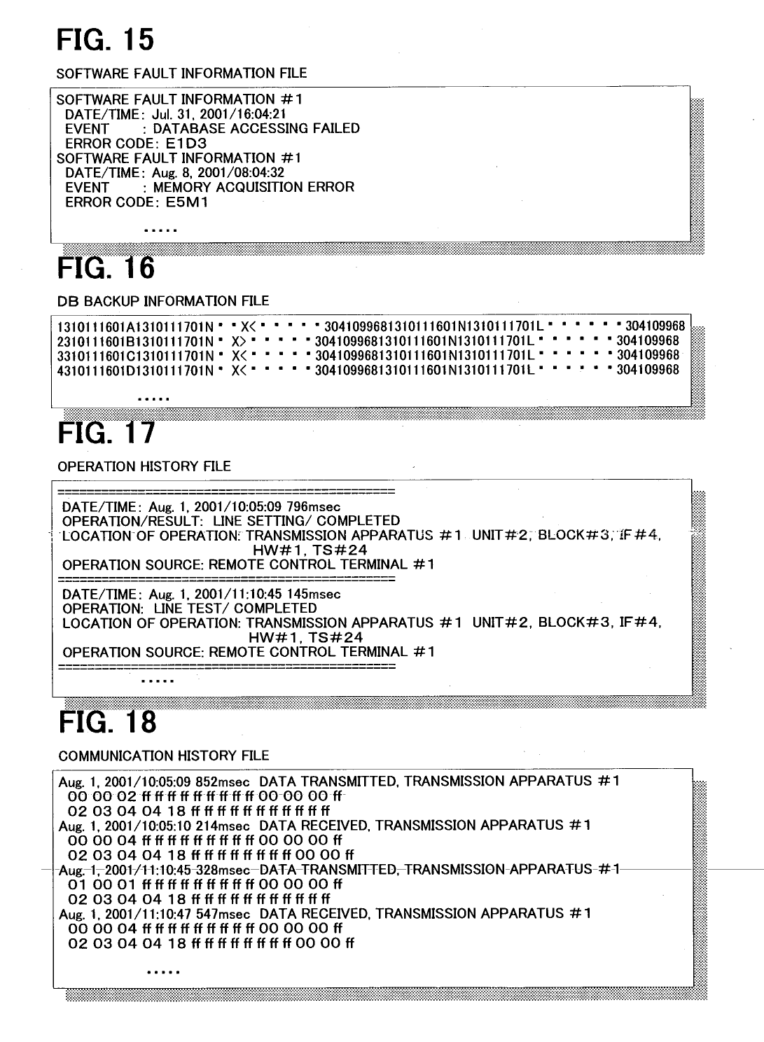

The description information in software fault information file 23 shown in FIG. 15 includes “date/time (when the software fault occurs)”, “event (the contents of software fault)” and “error code (a systematized code on the software or the contents in which a fault occurs)”.

The staff in charge of analysis receiving software fault information file 23 can recognize what sort of software fault has occurred by referring to the description information included in this file.

The description information in DB backup information file 24 shown in FIG. 16 includes data such as package registration information, line setting data, alarm produced, and package housing information stored in the database.

It is possible to restore the data in the database by supervision and control program unit 11 in supervision and control operation system 1, although maintenance staff or staff in charge of analysis cannot identify the contents by directly looking at the data.

The description information in operation history file 25 shown in FIG. 17 includes “operation date/time (when the operation is performed)”, “operation name and result (the operation contents and the processing result thereof)” and “location (a detailed location of the apparatus or inside the apparatus on which the operation is performed)” and “operation source (the point from which the operation is input, such as GUI unit 10 of supervision and control operation system 1, remote supervision and control terminal 3, etc.)”.

By preserving operation history file 25, the staff in charge of analysis receiving this file can refer to the operation information of supervision and control operation system 1 when the data becomes necessary for the survey.

The description information in communication history file 26 shown in FIG. 18 includes “communication date/time (when the communication is carried out)”, “opposite communication party (the external apparatus as an opposite party of communication)”, “communication data (the data received from the external apparatus or the data transmitted to the external apparatus”, etc.

By preserving communication history file 26, the staff in charge of analysis receiving the file can refer to the communication information exchanged between supervision and control operation system 1 and the external terminal when the data becomes necessary for the survey.

Now, the processing procedures of supervision and control program unit 11, mail transmission management program unit 14 and mail transmission program unit 15 for carrying out the method of the present invention are described in the following.

[Processing Procedure for Initial Activation of Supervision and Control Program Unit 11]

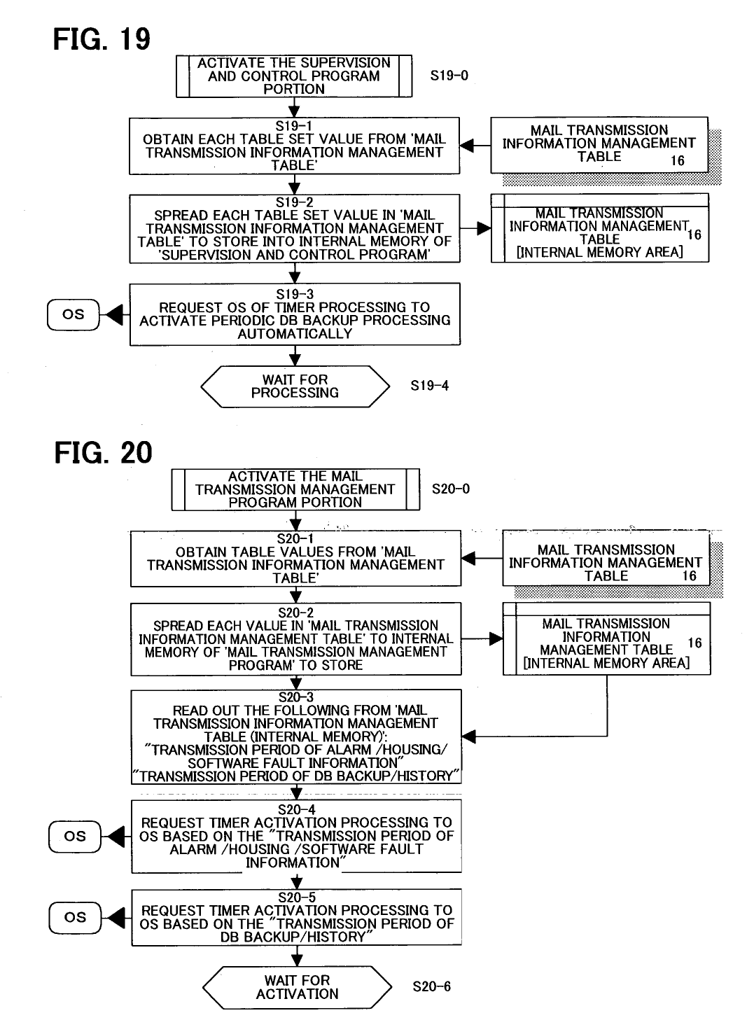

The processing procedure for the initial activation of supervision and control program unit 11 shown in FIG. 3 is described referring to FIG. 19.

When supervision and control program unit 11 is initially activated (S19-0) in FIG. 19, the processing is executed according to the following procedure.

(S19-1): Each set value in mail transmission information management table 16 is read out.

(S19-2): Each set value obtained from mail transmission information management table 16 is entirely retained after spreading to the internal memory of supervision and control program unit 11. This intends to obtain higher processing speed by reading out each set value from the internal memory in the processing of supervision and control program unit 11.

The structure of mail transmission information management table 16 being spread to the internal memory is identical to the structure of the table shown in FIG. 4.

(S19-3): In order to start backup processing of database 13 which is performed automatically and periodically, the activation processing by means of a timer is requested to the OS. In general, the period of once a day or the like is applied.

On completion of the above procedure, supervision and control program unit 11 reaches a state of waiting for processing to be activated by the control execution from the remote supervision and control terminal, the reception of an event from transmission apparatus 2, or the timer activation of periodical DB backup processing (S19-4).

[Processing for Initial Activation of Mail Transmission Management Program Unit 14]

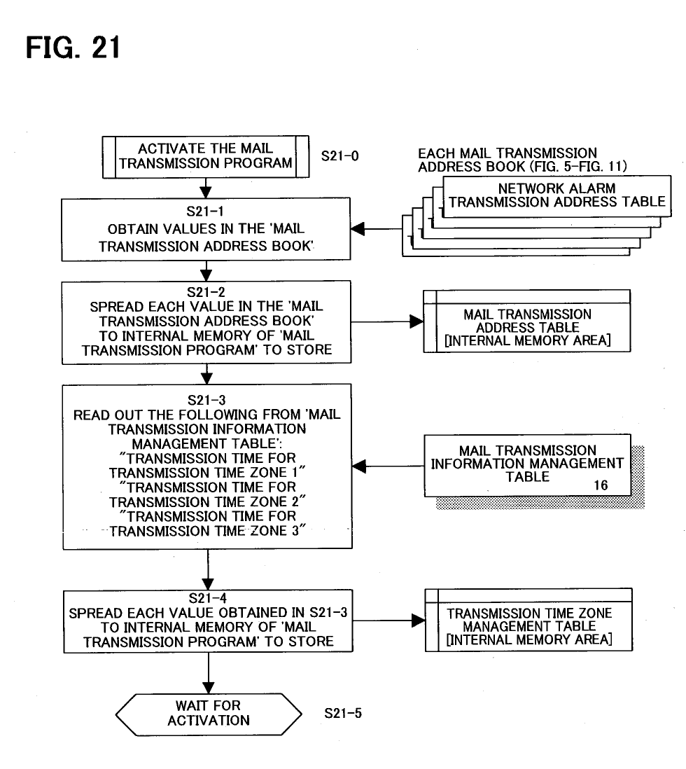

The processing procedure for initial activation of mail transmission management program unit 14 in the configuration shown in FIG. 3 is described below referring to FIG. 20.

In FIG. 20, when mail transmission management program unit 14 is initially activated (S20-0), the processing is executed according to the following procedure.

(S20-1): Each set value in mail transmission information management table 16 is read out.

(S20-2): Each set value obtained from mail transmission information management table 16 is entirely retained after spreading to the internal memory of mail transmission management program unit 14. This intends to obtain higher processing speed by reading out each set value from the internal memory in the processing of mail transmission management program unit 14.

The structure of mail transmission information management table 16 being spread to the internal memory is identical to the structure of the table shown in FIG. 4.

(S20-3): The values set in the following items are obtained from mail transmission information management table (internal memory) 16.

“Transmission period of alarm/package housing information/software fault information”

“Transmission period of DB backup/history”

(S20-4): A timer activation processing is requested to the OS so that this program is activated at each period specified in the “transmission period of alarm/package housing information/software fault information” obtained above.

(S20-5): A timer activation processing is requested to the OS so that this program is activated at each period specified in the “transmission period of DB backup/history” obtained above.

On completion of the above procedure, mail transmission management program unit 14 reaches a state of waiting for activation by the timers set in (S20-4) or (S20-5).

[Processing of Initial Activation of Mail Transmission Program Unit 15]

The processing procedure for initial activation of mail transmission program unit 15 in the configuration shown in FIG. 3 is described below referring to FIG. 21.

In FIG. 21, when mail transmission program unit 15 is initially activated (S21-0), the processing is executed according to the following procedure.

(S21-1): Each set value in mail transmission address book (FIG. 5 to FIG. 11) is read out.

(S21-2): The set value obtained from each mail transmission address book is entirely retained after spreading to the internal memory of mail transmission program unit 15. This intends to obtain higher processing speed by reading out each set value from the internal memory in the processing of mail transmission program unit 15.

The structure of mail transmission information management table 16 being spread to the internal memory is identical to the structure of the table shown in FIG. 4.

(S21-3): The values set in the following items are read out from mail transmission information management table 16.

“Transmission time in transmission time zone 1”

“Transmission time in transmission time zone 2”

“Transmission time in transmission time zone 3”

(S21-4): The set value obtained from each mail transmission information management table 16 is entirely retained after spreading to the internal memory of mail transmission program unit 15. This intends to obtain higher processing speed by reading out each set value from the internal memory in the processing of mail transmission program unit 15.

The structure of mail transmission information management table 16 being spread to the internal memory is identical to the structure of [transmission time in transmission time zone 1] to [transmission time in transmission time zone 3] in the common data unit 161 shown in FIG. 4.

On completion of the above procedure, mail transmission program unit 15 reaches the state of waiting for activation from mail transmission management program unit 14 (S21-5).

[Each File Generation/Updating Processing for Mail Transmission by the Supervision and Control Program Unit]

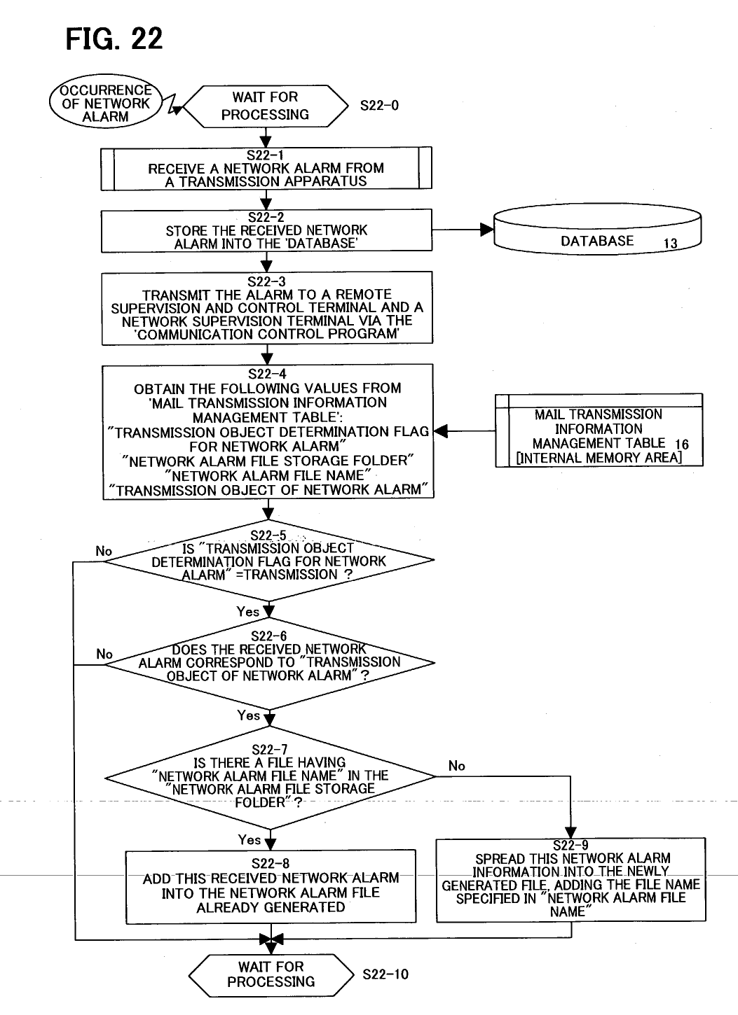

Hereafter the file generation/updating processing for network alarm file 20, apparatus fault alarm file 21, package housing information file 22, software fault information file 23, DB backup information file 24, operation history file 25 and communication history file 26 by supervision and control program unit 11 in the configuration shown in FIG. 3 is described referring to FIGS. 22-28.

FIG. 22 illustrates the processing procedure from when a network alarm is notified from the transmission apparatus to when network alarm file 20 is generated or updated.

(S22-1): In the state of waiting for processing (S22-0), on reception of a network alarm from transmission apparatus 2, supervision and control program unit 11 starts the processing.

(S22-2): The received network alarm is stored in database 13 so as to display the past alarms completely when alarm retrieval is requested from GUI unit 10 or remote supervision and control terminal 3.

(S22-3): The received network alarm is transmitted to remote supervision and control terminal 3 and network supervision terminal 4 via communication control program unit 12 to display.

(S22-4): The values set in the following items are extracted from mail transmission information management table (internal memory) 16, which are necessary for the succeeding processing.

“Transmission object determination flag for network alarm”

“Network alarm file storage folder”

“Network alarm file name”

“Transmission object of network alarm”

(S22-5): It is determined whether “transmission object determination flag for network alarm” is defined as “transmission”.

(S22-6): It is determined whether the network alarm received this time is defined as the “transmission object of network alarm”.

(S22-7): It is determined whether the network alarm file for mail transmission is already generated in the “network alarm file storage folder”.

(S22-8): When network alarm file 20 for mail transmission is already generated, the information related to the network alarm which is received this time is added to the tail unit of the file.

(S22-9): When network alarm file 20 for mail transmission is not generated, a new file is generated in the folder of interest to spread the network alarm received this time from the top of the file. A file name defined in the “network alarm file name” is applied to the newly generated file.

Through the aforementioned procedure, generation or updating of network alarm file 20 is completed. Supervision and control program unit 11 again reaches the state of waiting for activation by control execution from remote supervision and control terminal 3, event reception from transmission apparatus 2, or timer activation of periodic DB backup processing (S22-10).

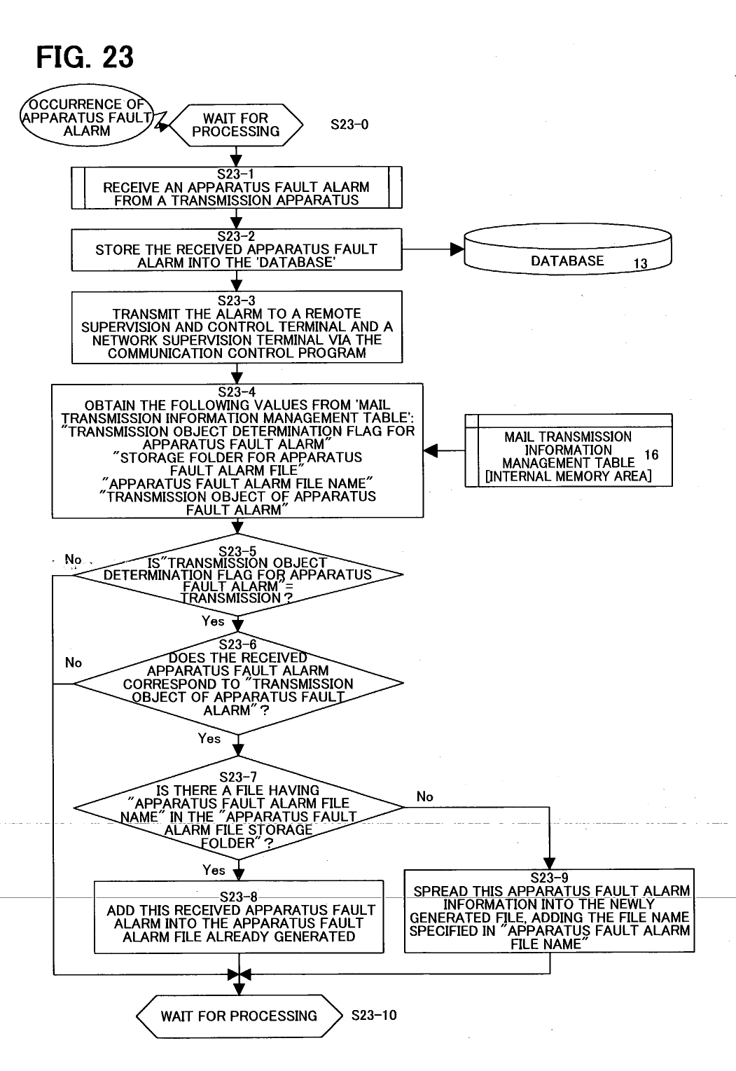

FIG. 23 illustrates the processing procedure from when an apparatus fault alarm is notified from the transmission apparatus 2 to when apparatus fault alarm file 21 is generated or updated.

(S23-1): In the state of waiting for processing (S23-0), on reception of an apparatus fault alarm from transmission apparatus 2, supervision and control program unit 11 starts the processing.

(S23-2): The received apparatus fault alarm is stored in database 13 so as to display the past alarms completely when alarm retrieval is requested from GUI unit 10 or remote supervision and control terminal 3.

(S23-3): The received network alarm is transmitted to remote supervision and control terminal 3 and network supervision terminal 4 via communication control program unit 12 to display.

(S23-4): The values set in the following items are extracted from mail transmission information management table (internal memory) 16, which are necessary for the succeeding processing.

“Transmission object determination flag for apparatus fault alarm”

“Storage folder for apparatus fault alarm file”

“Apparatus fault alarm file name”

“Transmission object of apparatus fault alarm”

(S23-5): It is determined whether “transmission object determination flag for apparatus fault alarm” is defined as “transmission”.

(S23-6): It is determined whether the apparatus fault alarm received this time is defined as the “transmission object of apparatus fault alarm”.

(S23-7): It is determined whether apparatus fault alarm file 21 for mail transmission is already generated in the “storage folder for apparatus fault alarm file”.

(S23-8): When apparatus fault alarm file 21 for mail transmission is already generated, the information related to the apparatus fault alarm which is received this time is added to the tail unit of the file.

(S23-9): When apparatus fault alarm file 21 for mail transmission is not generated, a new file is generated in the folder of interest to spread the apparatus fault alarm received this time from the top of the file. A file name defined in the “apparatus fault alarm file name” is applied to the newly generated file.

Through the aforementioned procedure, generation or updating of apparatus fault alarm file 21 is completed. Supervision and control program unit 11 again reaches the state of waiting for activation by control execution from remote supervision and control terminal 3, event reception from transmission apparatus 2, or timer activation of periodic DB backup processing (S23-10).

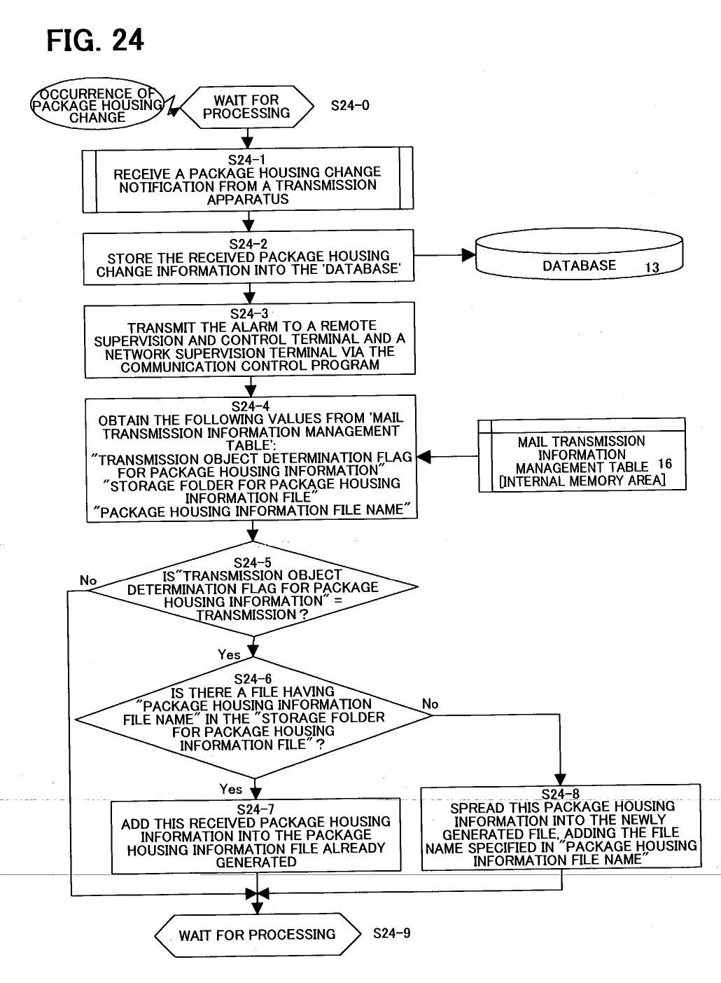

FIG. 24 illustrates the processing procedure from when package housing change information is notified from the transmission apparatus 2 to when package housing information file 22 is generated or updated.

(S24-1): In the state of waiting for processing (S24-0), on reception of package housing change information from transmission apparatus 2, supervision and control program unit 11 starts the processing.

(S24-2): The received package housing information is stored in database 13 so as to display the current package housing condition completely when package housing information retrieval is requested from GUI unit 10 or remote supervision and control terminal 3.

(S24-3): The received package housing change information is transmitted to remote supervision and control terminal 3 via communication control program unit 12 to display.

(S24-4): The values set in the following items are extracted from mail transmission information management table (internal memory) 16, which are necessary for the succeeding processing.

“Transmission object determination flag for package housing information”

“Storage folder for package housing information file”

“Package housing information file name”

(S24-5): It is determined whether “transmission object determination flag for package housing information” is defined as “transmission”.

(S24-6): It is determined whether package housing information file 22 for mail transmission is already generated in the “storage folder for package housing information file”.

(S24-7): When package housing information file 22 for mail transmission is already generated, the information related to the package housing information which is received this time is added to the tail unit of the file.

(S24-8): When package housing information file 22 for mail transmission is not generated, a new file is generated in the folder of interest to spread the package housing information received this time from the top of the file. A file name defined in the “package housing information file name” is applied to the newly generated file.

Through the aforementioned procedure, generation or updating of package housing information file 22 is completed. Supervision and control program unit 11 again reaches the state of waiting for activation by control execution from remote supervision and control terminal 3, event reception from transmission apparatus 2, or timer activation of periodic DB backup processing (S24-9).

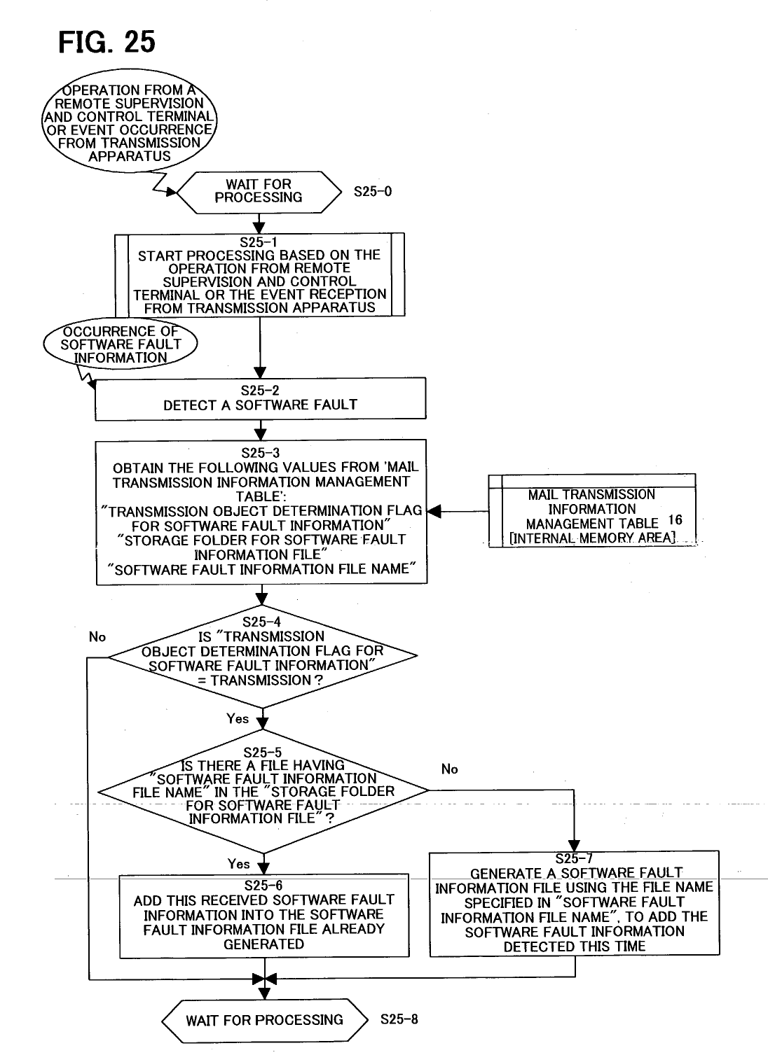

FIG. 25 illustrates the processing procedure from when supervision and control operation system 1 detects a software fault which occurs inside the system to when software fault information file 23 is generated or updated.

(S25-1): In the state of waiting for processing (S25-0), on reception of an event from transmission apparatus 2, supervision and control program unit 11 starts the processing.

(S25-2): A software fault in the own program or the related program is detected during execution of an application program of supervision and control operation system 1.

(S25-3): The values set in the following items are extracted from mail transmission information management table (internal memory area) 16, which are necessary for the succeeding processing.

“Transmission object determination flag for software fault information”

“Storage folder for software fault information file”

“Software fault information file name”

(S25-4): It is determined whether “transmission object determination flag for software fault information” is defined as “transmission”.

(S25-5): It is determined whether software fault information file 23 for mail transmission is already generated in the “storage folder for software fault information file”.

(S25-6): When software fault information file 23 for mail transmission is already generated, the information related to the software fault information which is received this time is added to the tail unit of the file.

(S25-7): When software fault information file 23 for mail transmission is not generated, a new file is generated in the folder of interest to-spread the software fault information received this time from the top of the file. A file name defined in the “software fault information file name” is applied to the newly generated file.

Through the aforementioned procedure, generation or updating of software fault information file 23 is completed. Supervision and control program unit 11 again reaches the state of waiting for activation by control execution from remote supervision and control terminal 3, event reception from transmission apparatus 2, or timer activation of periodic DB backup processing (S25-8).

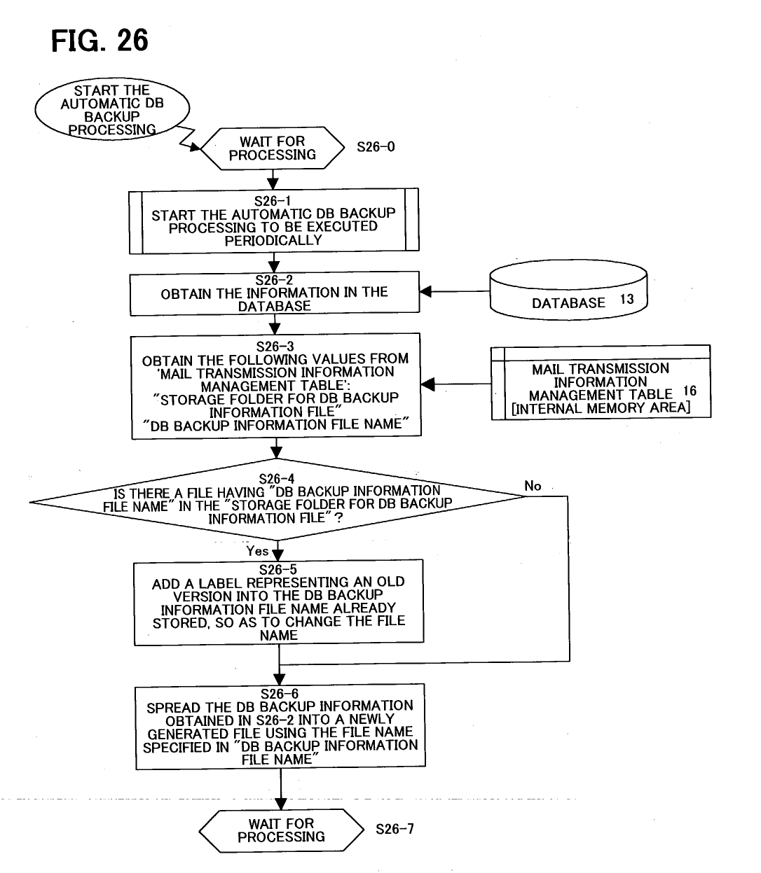

Next, FIG. 26 illustrates the processing procedure from when supervision and control operation system 1 starts automatic DB backup processing to when DB backup information file 24 is generated or updated.

(S26-1): In the state of waiting for processing (S26-0), activated by the timer from the OS, supervision and control program unit 11 starts the automatic DB backup processing.

(S26-2): The entire data stored in database 13 is obtained.

(S26-3): The values set in the following items are extracted from mail transmission information management table (internal memory area) 16, which are necessary for the succeeding processing.

“Storage folder for DB backup information file”

“DB backup information file name”

(S26-4): It is determined whether DB backup information file 24 is already generated in the “storage folder for DB backup information file”.

(S26-5): When DB backup information file 24 is already generated, a label representing an old version is given as the file name of the file concerned, and thus the file name is changed.

(S26-6): A new file is generated in the folder of interest to spread the entire data of the DB backup information obtained. A file name defined in the “DB backup information file name” is applied to the newly generated file.

Through the aforementioned procedure, generation or updating of DB backup information file 24 is completed. Supervision and control program unit 11 again reaches the state of waiting for activation by control execution from remote supervision and control terminal 3, event reception from transmission apparatus 2, or timer activation of periodic DB backup processing (S26-7).

In the above-mentioned processing of generating DB backup information file 24, the determination of whether “transmission object determination flag for DB backup information” is set as “transmission” is not performed. In other words, this procedure generates DB backup information file 24 at all times.

The reason is that DB backup information file 24 is necessary whenever trying to restore from a serious fault having occurred in supervision and control operation system 1 which results in destruction of DB backup information file 24. Therefore, according to the above-mentioned procedure, DB backup information file 24 is generated at any time irrespective of existence or non-existence of a mail transmission object.

In a system which does not require DB backup information file 24 when restoring the system, it may also be possible to exclude DB backup information file 24 from the transmission object.

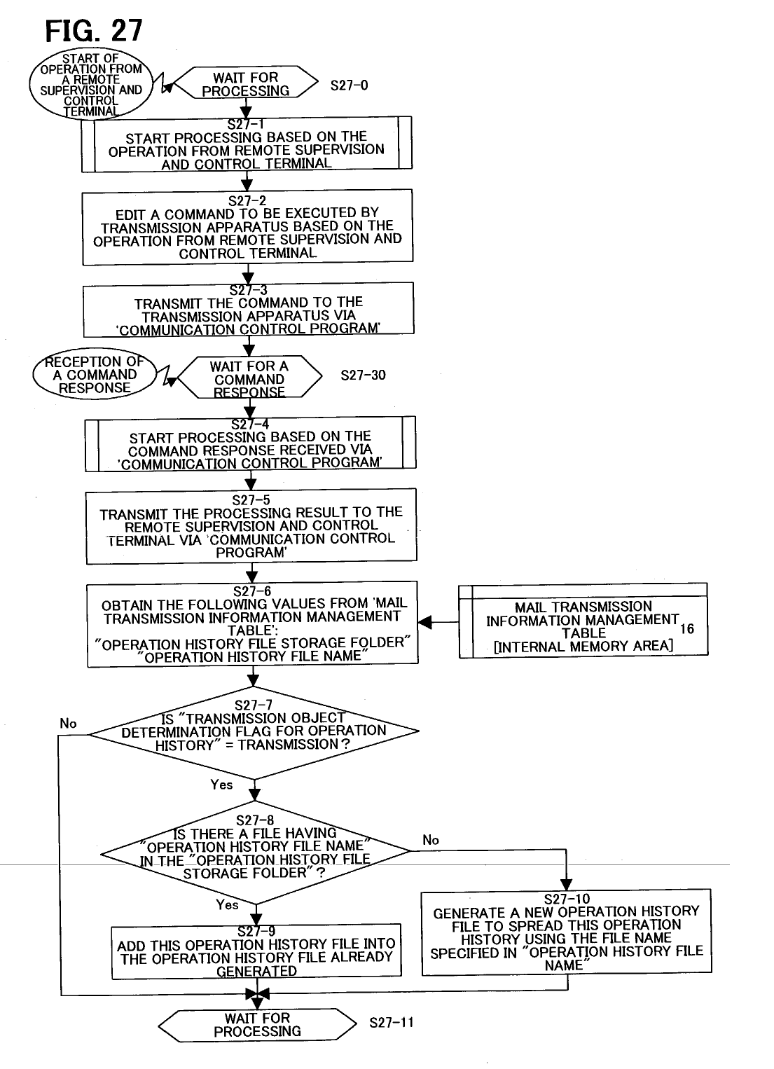

FIG. 27 illustrates the processing procedure up to when operation history file 25 is generated or updated according to the control of remote supervision and control terminal 3.

(S27-1): In the state of waiting for processing (S27-0), by the operation from remote supervision and control terminal 3, supervision and control program unit 11 starts the processing.

(S27-2): A command to be performed in transmission apparatus 2 is edited based on the operation from remote supervision and control terminal 3.

(S27-3): The command is transmitted to transmission apparatus 2 via communication control program unit 12.

(S27-4): On reception of command reply from transmission apparatus 2 (S27-30), supervision and control program unit 11 restarts processing.

(S27-5): The command processing result against transmission apparatus 2 is transmitted to remote supervision and control terminal 3 originating the operation via communication control program unit 12.

(S27-6): The values set in the following items are extracted from mail transmission information management table (internal memory area) 16, which are necessary for the succeeding processing.

“Transmission object determination flag for operation history file”

“Operation history file storage folder”

“Operation history file name”

(S27-7): It is determined whether “transmission object determination flag for operation history file” is defined as “transmission”.

(S27-8): It is determined whether operation history file 25 for mail transmission is already generated in the “operation history file storage folder”.

(S27-9): When operation history file 25 for mail transmission is already generated, the information related to the operation history which is executed this time is added to the tail unit of the file.

(S27-10): When operation history file 25 for mail transmission is not generated, a new file is generated in the folder of interest to spread the software fault information received this time from the top of the file. A file name defined in the “operation history file-name” is applied to the newly generated file.

Through the aforementioned procedure, generation or updating of operation history file 25 is completed. Supervision and control program unit 11 again reaches the state of waiting for activation by control execution from remote supervision and control terminal 3, event reception from transmission apparatus 2, or timer activation of periodic DB backup processing (S27-11).

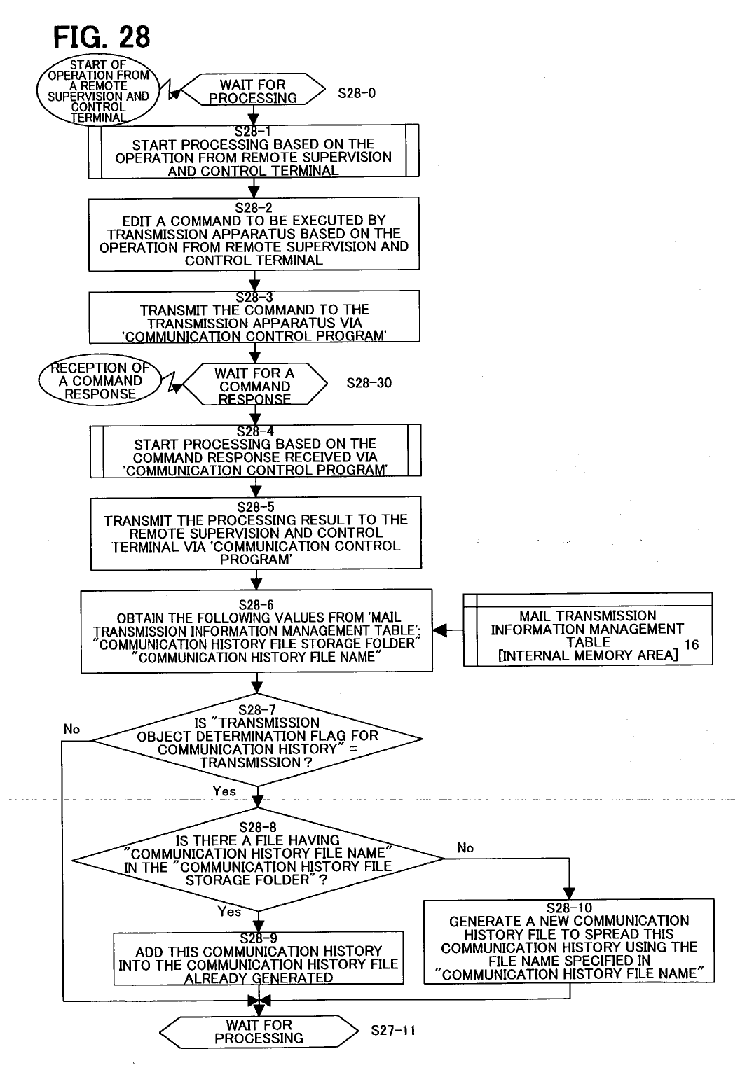

FIG. 28 illustrates the processing procedure up to when communication history file 26 is generated or updated according to the control of remote supervision and control terminal 3.

(S28-1): In the state of waiting for processing (S28-0), by the operation from remote supervision and control terminal 3, supervision and control program unit 11 starts the processing.

(S28-2): A command to be performed in transmission apparatus 2 is edited based on the operation from remote supervision and control terminal 3.

(S28-3): The command is executed against transmission apparatus 2 by transmitting through communication control program unit 12.

(S28-4): On reception of a command reply from transmission apparatus 2, supervision and control program unit 11 restarts processing.

(S28-5): The command processing result against transmission apparatus 2 is transmitted to remote supervision and control terminal 3 originating the operation via communication control program unit 12.

(S28-6): The values set in the following items are extracted from mail transmission information management table (internal memory area) 16, which are necessary for the succeeding processing.

“Transmission object determination flag for communication history file”

“Communication history file storage folder”

“Communication history file name”

(S28-7): It is determined whether “transmission object determination flag for communication history file” is defined as “transmission”.

(S28-8): It is determined whether communication history file 26 for mail transmission is already generated in the “communication history file storage folder”.

(S28-9): When communication history file 26 for mail transmission is already generated, the information related to the operation which is executed this time is added to the tail unit of the file.

(S28-10): When communication history file 26 for mail transmission is not generated, a new file is generated in the folder of interest to spread the software fault information received this time from the top of the file. A file name defined in the “communication history file name” is applied to the newly generated file.

Through the aforementioned procedure, generation or updating of communication history file 26 is completed. Supervision and control program unit 11 again reaches the state of waiting for activation by control execution from remote supervision and control terminal 3, event reception from transmission apparatus 2, or timer activation of periodic DB backup processing (S28-11).

[File Detection Processing for Mail Transmission by the Mail Transmission Management Program Unit]

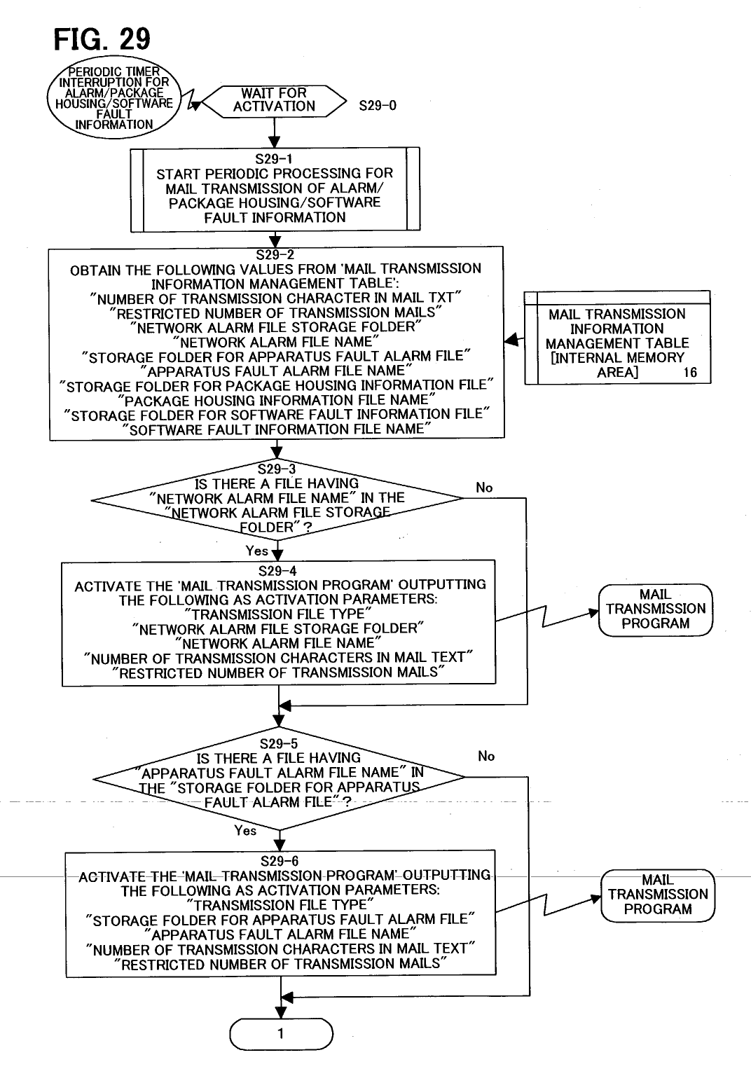

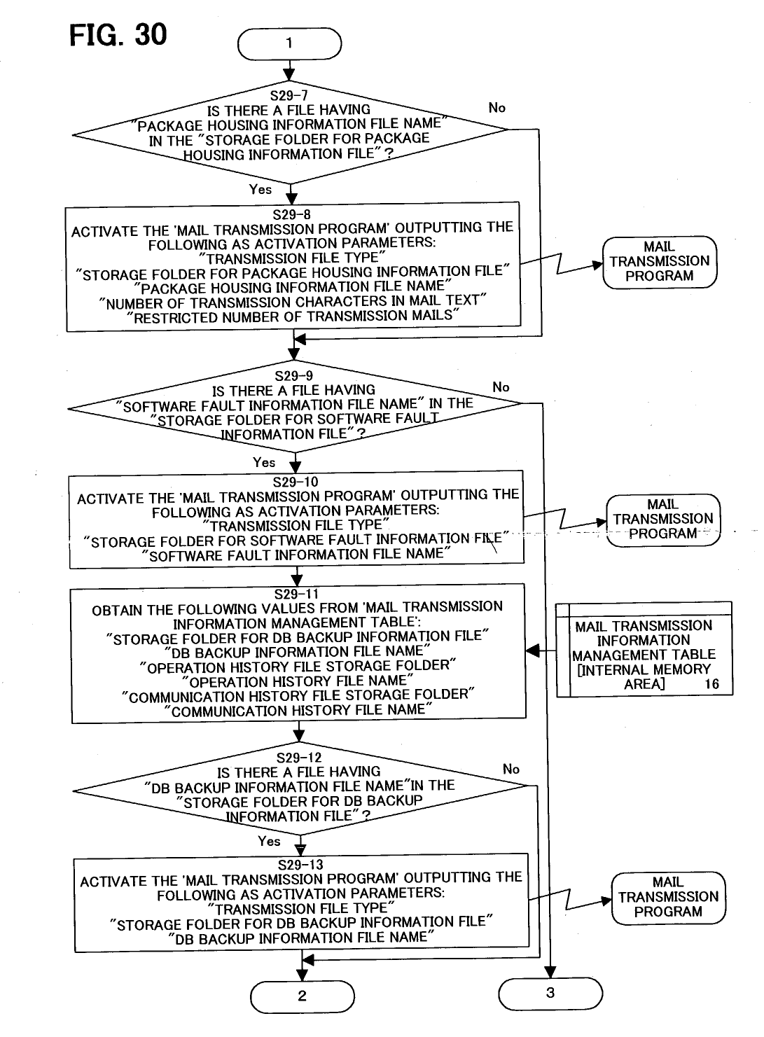

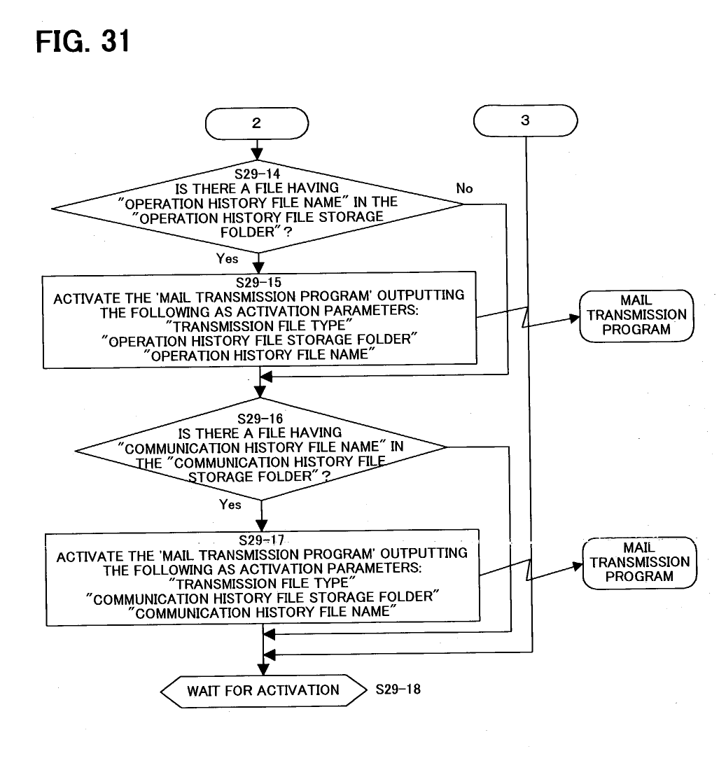

In the configuration shown in FIG. 3, their is explained referring to FIGS. 29-32 the processing from when mail transmission management program unit 14 detects the following files to be transmitted, i.e. network alarm file 20, apparatus fault alarm file 21, package housing information file 22, software fault information file 23, DB backup information file 24, operation history file 25, and communication history file 26, to when a mail transmission request is issued to mail transmission program unit 15.

FIG. 29 illustrates the processing procedure from when mail transmission management program unit 14 waiting for activation in the processing shown in FIG. 20 (S20-6) is activated by the mail transmission interval timer for alarm/package housing information/software fault information to when mail transmission management program unit 14 requests mail transmission program unit 15 for mail transmission.

(S29-1): In the sate of waiting for activation (S29-0), mail transmission management program unit 14 starts processing periodically activated by the timer from the OS.

(S29-2): The values set in the following items are extracted from mail transmission information management table (internal memory area) 16, which are necessary for the succeeding processing.

“Number of transmission characters in mail txt”

“Restricted number of transmission mails”

“Network alarm file storage folder”

“Network alarm file name”

“Storage folder for apparatus fault alarm file”

“Apparatus fault alarm file name”

“Storage folder for package housing information file”

“Package housing information file name”

“Storage folder for software fault information file”

“Software fault information file name”

(S29-3): It is determined whether a file having a file name identical to the “network alarm file name” exists in the “network alarm file storage folder”.

(S29-4) When the file having the file name identical to the “network alarm file name” exists, mail transmission program unit 15 is activated to request for transmission of the file concerned as a mail transmission object.

Here, the following information required for mail transmission of the file by mail transmission program unit 15 is output as activation parameters.

“Transmission file type” (in this case, network alarm file)

“Network alarm file storage folder”

“Network alarm file name”

“Number of transmission characters in mail text”

“Restricted number of transmission mails”

(S29-5): It is determined whether a file having a file name identical to the “apparatus fault alarm file name” exists in the “storage folder for apparatus fault alarm file”.

(S29-6): When the file having the file name identical to the “apparatus fault alarm file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, apparatus fault alarm file)

“Storage folder for apparatus fault alarm file”

“Apparatus fault alarm file name”

“Number of transmission characters in mail text”

“Restricted number of transmission mails”

(S29-7): It is determined whether a file having a file name identical to the “package housing information file name” exists in the “storage folder for package housing information file”.

(S29-8): When the file having the file name identical to the “package housing information file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, package housing information file)

“Package housing information storage folder”

“Package housing information file name”

“Number of transmission characters in mail text”

“Restricted number of transmission mails”

(S29-9): It is determined whether a file having a file name identical to the “software fault information file name” exists in the “storage folder for software fault information file”.

(S29-10) When the file having the file name identical to the “software fault information file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, software fault information file)

“Storage folder for software fault information”

“Software fault information file name”

Here, when the mail transmission of software fault information is requested in (S20-10), transmission processing of DB backup information, operation history, and communication history which are necessary for investigation and analysis of the software fault is also executed. This processing is described in (S29-11) and after.

Further, when the software fault information is not requested for mail transmission, the processing procedure shown in FIG. 29 is completed and mail transmission management program unit 14 again reaches the state of waiting for activation by the OS.

(S29-11): The values set in the following items are extracted from mail transmission information management table (internal memory area) 16, which are necessary for the succeeding processing.

“Storage folder for DB backup information file”

“DB backup information file name”

“Operation history file storage folder”

“Operation history file name”

“Communication history file storage folder”

“Communication history file name”

(S29-12): It is determined whether a file having a file name identical to the “DB backup information file name” exists in the “storage folder for DB backup information file”.

(S29-13): When the file having the file name identical to the “DB backup information file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, DB backup information file)

“Storage folder for DB backup information file”

“DB backup information file name”

(S29-14): It is determined whether a file having a file name identical to the “operation history file name” exists in the “operation history file storage folder”.

(S29-15): When the file having the file name identical to the “operation history file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, operation history file)

“Operation history file storage folder”

“Operation history file name”

(S29-16): It is determined whether a file having a file name identical to the “communication history file name” exists in the “communication history file storage folder”.

(S29-17): When the file having the file name identical to the “communication history file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, communication history file)

“Communication history file storage folder”

“Communication history file name”

Thereafter, the process returns to the state of waiting for activation (S29-18).

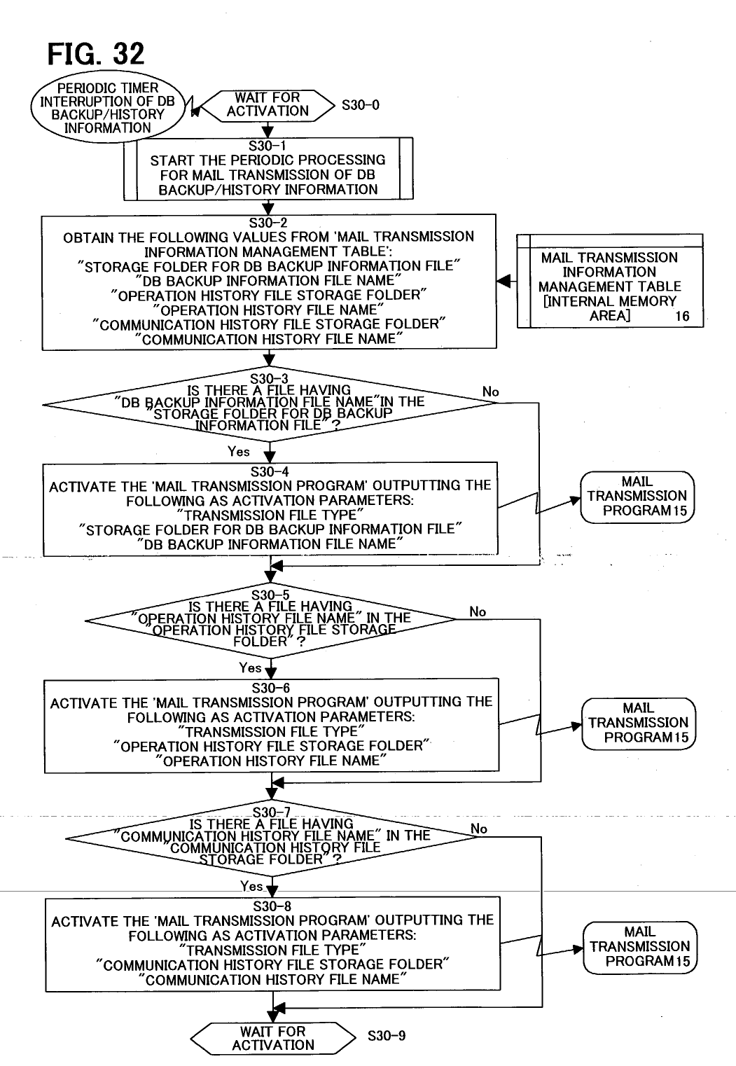

FIG. 32 illustrates the processing procedure from when mail transmission management program unit 14 waiting for activation in the processing shown in FIG. 20 (S20-6) is activated by the mail transmission interval timer of DB backup/history information to when mail transmission management program unit 14 requests mail transmission program unit 15 for mail transmission.

(S30-1): In the sate of waiting for activation (S30-0), mail transmission management program unit 14 starts processing periodically activated by the timer from the OS.

(S30-2): The values set in the following items are extracted from mail transmission information management table (internal memory area) 16, which are necessary for the succeeding processing.

“Storage folder for DB backup information file”

“DB backup information file name”

“Operation history file storage folder”

“Operation history file name”

“Communication history file storage folder”

“Communication history file name”

(S30-3): It is determined whether a file having a file name identical to the “DB backup information file name” exists in the “storage folder for DB backup information file”.

(S30-4) When the file having the file name identical to the “DB backup information file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, DB backup information file)

“Storage folder for DB backup information file”

“DB backup information file name”

(S30-5): It is determined whether a file having a file name identical to the “operation history file name” exists in the “operation history file storage folder”.

(S30-6): When the file having the file name identical to the “operation history file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, operation history file)

“Operation history file storage folder”

“Operation history file name”

(S30-7): It is determined whether a file having a file name identical to the “communication history file name” exists in the “communication history file storage folder”.

(S30-8): When the file having the file name identical to the “communication history file name” exists, mail transmission program unit 15 is activated to request for transmission of the file concerned as a mail transmission object.

Here, the following information required for mail transmission of the file is input to mail transmission program unit 15 as activation parameters.

“Transmission file type” (in this case, communication history file)

“Package housing information storage folder”

“Communication history file name”

After the above-mentioned procedure is completed, mail transmission management program unit 14 reaches again the state waiting for activation from the OS (S30-9).

In the procedure shown in FIGS. 29-32, activation request from mail transmission management program unit 14 to mail transmission program unit 15 may possibly be performed for a plurality of times. In such a case, mail transmission program unit 15 successively executes the mail transmission processing for the received numbers of requests issued from mail transmission management program unit 14.

[Mail Transmission Processing by the Mail Transmission Program Unit]

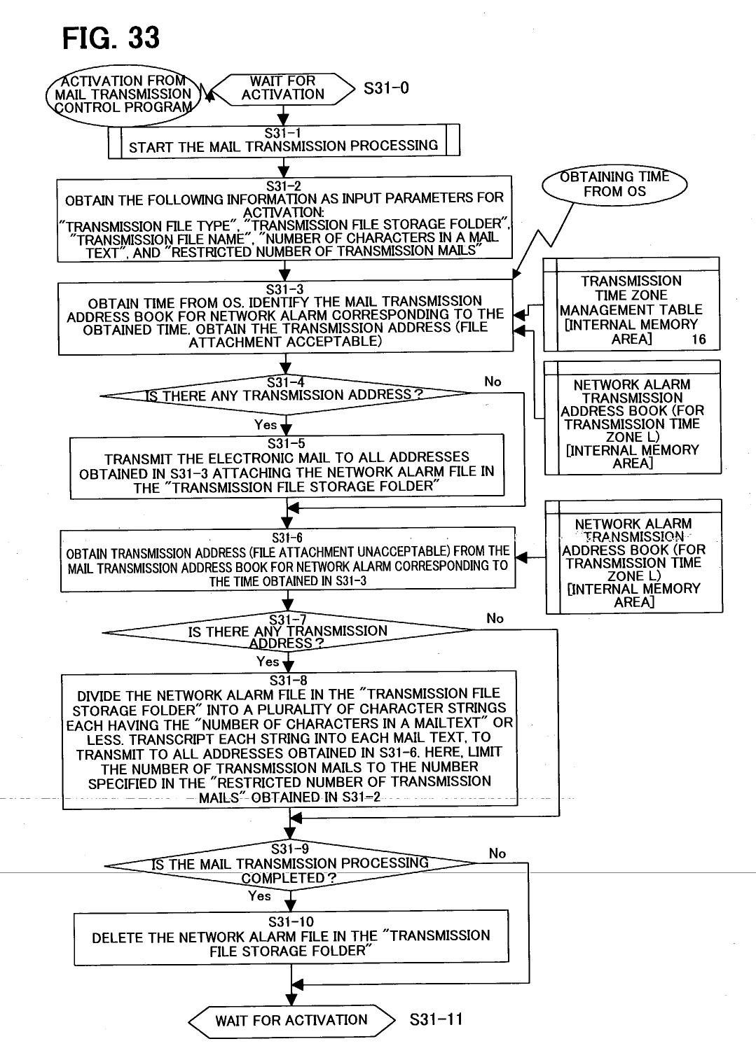

Next, referring to FIGS. 33-39, the processing from when mail transmission program unit 15 in the configuration shown in FIG. 3 receives mail transmission request from mail transmission management program unit 14 to when mail transmission program unit 15 transmits a mail transmission object file, i.e. network alarm file 20, apparatus fault alarm file 21, package housing information file 22, software fault information file 23, DB backup information file 24, operation history file 25 or communication history file 26, is described.

FIG. 33 illustrates a processing procedure from when mail transmission program unit 15 waiting for activation in the processing shown in FIG. 20 receives a transmission request of network alarm file 20 from mail transmission management program unit 14 to when mail transmission is executed.

(S31-1): In the sate of waiting for activation (S31-0), mail transmission program unit 15 starts processing activated by mail transmission management program unit 14.

(S31-2): The following parameters are input as parameters at the time of activation from mail transmission management program unit 14.

“Transmission file type” (in this case, network alarm file)

“Transmission file storage folder”

“Transmission file name”

“Number of characters in a mail text”

“Restricted number of transmission mails”

(S31-3): Mail transmission program unit 15 obtains current time from the OS to determine the time zone L (L=1-3) corresponding to the current time using transmission time zone management table 16. Identifying the transmission address book for network alarm (transmission time zone L) corresponding to the time zone L using the mail transmission address book stored in the internal memory, mail transmission program unit 15 obtains a transmission address for network alarm (file attachment acceptable).

(S31-4): It is determined whether there is a setting of the transmission address for network alarm (file attachment acceptable).

(S31-5): The file having a file name identical to the file name of “transmission file name” stored in “transmission file storage folder” is transmitted as an attached file to the transmission address for network alarm (file attachment acceptable).

At this time, if there exist a plurality of transmission addresses for network alarm (file attachment acceptable), the file is transmitted to the entire addresses in broadcast form.

(S31-6): A mail transmission address for network alarm (file attachment unacceptable) is obtained from the transmission address book for network alarm (transmission time zone L).

(S31-7): It is determined whether there is a setting of a transmission address for network alarm (file attachment unacceptable).

(S31-8): The description information in the file having a file name identical to the “transmission file name” stored in the “transmission file storage folder” is divided so that each divided unit does not exceed the limit of “number of characters in a mail text”, to transmit for a plurality of times to the transmission address for network alarm (file attachment unacceptable). If there exist a plurality of transmission addresses for network alarm (file attachment unacceptable), the file is transmitted to the entire addresses in broadcast form.

Here, the maximum number of transmission in the case of transmitting mails for a plurality of times is not to exceed the “Restricted number of transmission mails”. When the number exceeds, the transmission processing is suspended.

(S31-9): It is determined whether the transmission processing for network alarm file 20 is completed.

(S31-10): When transmission processing for network alarm file 20 is completed, network alarm file 20 stored in the “transmission file storage folder”, the transmission of which is completed, is deleted.

On completion of the aforementioned procedure, mail transmission program unit 15 reaches the state of waiting for activation from mail transmission management program unit 14 (S31-11).

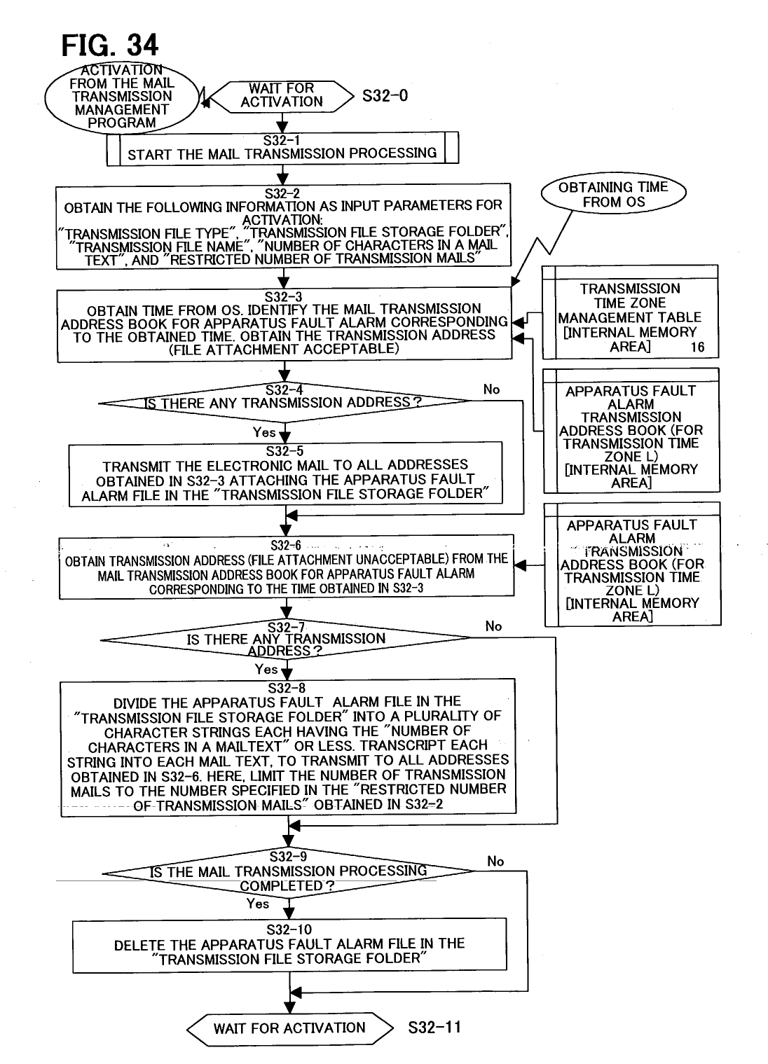

FIG. 34 illustrates a processing procedure up to when mail transmission program unit 15 executes mail transmission of apparatus fault alarm file 21.

(S32-1): In the sate of waiting for activation (S32-0), mail transmission program unit 15 starts processing activated by mail transmission management program unit 14.

(S32-2): The following parameters are input as parameters at the time of activation from mail transmission management program unit 14.

“Transmission file type” (in this case, apparatus fault alarm file)

“Transmission file storage folder”

“Transmission file name”

“Number of characters in a mail text”

“Restricted number of transmission mails”

(S32-3): Mail transmission program unit 15 obtains current time from the OS to determine the time zone L (L=1-3) corresponding to the current time using transmission time zone management table 16. Identifying the transmission address book for apparatus fault alarm (transmission time zone L) corresponding to the time zone L using the mail transmission address book stored in the internal memory, mail transmission program unit 15 obtains a transmission address for apparatus fault alarm (file attachment acceptable).

(S32-4): It is determined whether there is a setting of the transmission address for apparatus fault alarm (file attachment acceptable).

(S32-5): The file having a file name identical to the file name of “transmission file name” stored in “transmission file storage folder” is transmitted as an attached file to the transmission address for apparatus fault alarm (file attachment acceptable).

At this time, if there exist a plurality of transmission addresses for apparatus fault alarm (file attachment acceptable), the file is transmitted to the entire addresses in broadcast form.

(S32-6): A mail transmission address for apparatus fault alarm (file attachment unacceptable) is obtained from the transmission address book for apparatus fault alarm (transmission time zone L).

(S32-7): It is determined whether there is a setting of a transmission address for apparatus fault alarm (file attachment unacceptable).

(S32-8): The description information in the file having a file name identical to the “transmission file name” stored in the “transmission file storage folder” is divided so that each divided unit does not exceed the limit of “number of characters in a mail text”, to transmit for a plurality of times to the transmission address for apparatus fault alarm (file attachment unacceptable). If there exist a plurality of transmission addresses for apparatus fault alarm (file attachment unacceptable), the file is transmitted to the entire addresses in broadcast form.

Here, the maximum number of transmission in the case of transmitting mails for a plurality of times is not to exceed the “Restricted number of transmission mails”. When the number exceeds, the transmission processing is suspended.

(S32-9): It is determined whether the transmission processing for apparatus fault alarm file 21 is completed.

(S32-10): When transmission processing for apparatus fault alarm file 21 is completed, apparatus fault alarm file 21 having been transmitted is deleted from the “transmission file storage folder”.

On completion of the aforementioned procedure, mail transmission program unit 15 reaches the state of waiting for activation from mail transmission management program unit 14 (S32-11).

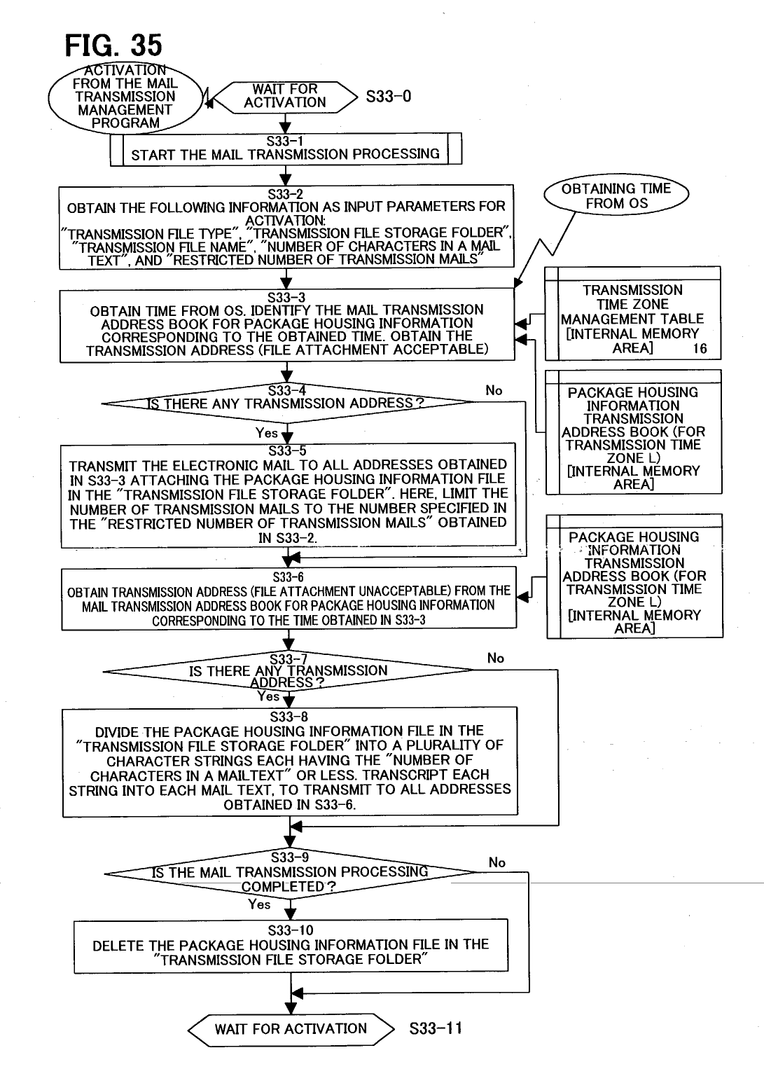

FIG. 35 illustrates a processing procedure up to when mail transmission program unit 15 executes mail transmission of package housing information file 22.

(S33-1): In the sate of waiting for activation (S33-0), mail transmission program unit 15 starts processing activated by mail transmission management program unit 14.

(S33-2): The following parameters are input as parameters at the time of activation from mail transmission management program unit 14.

“Transmission file type” (in this case, package housing information file)

“Transmission file storage folder”

“Transmission file name”

“Number of characters in a mail text”

“Restricted number of transmission mails”

(S33-3): Mail transmission program unit 15 obtains current time from the OS to determine the time zone L (L=1-3) corresponding to the current time using transmission time zone management table 16. Identifying the transmission address book for package housing information (transmission time zone L) corresponding to the time zone L using the mail transmission address book stored in the internal memory, mail transmission program unit 15 obtains a transmission address for package housing information (file attachment acceptable).

(S33-4): It is determined whether there is a setting of the transmission address for package housing information (file attachment acceptable).

(S33-5): The file having a file name identical to the file name of “transmission file name” stored in “transmission file storage folder” is transmitted as an attached file to the transmission address for package housing information (file attachment acceptable).

At this time, if there exist a plurality of transmission addresses for package housing information (file attachment acceptable), the file is transmitted to the entire addresses in broadcast form.

(S33-6): A mail transmission address for package housing information (file attachment unacceptable) is obtained from the transmission address book for package housing information (transmission time zone L).

(S33-7): It is determined whether there is a setting of a transmission address for package housing information (file attachment unacceptable).

(S33-8): The description information in the file having a file name identical to the “transmission file name” stored in the “transmission file storage folder” is divided so that each divided unit does not exceed the limit of “number of characters in a mail text”, to transmit for a plurality of times to the transmission address for package housing information (file attachment unacceptable). If there exist a plurality of transmission addresses for package housing information (file attachment unacceptable), the file is transmitted to the entire addresses in broadcast form.

Here, the maximum number of transmission in the case of transmitting mails for a plurality of times is not to exceed the “Restricted number of transmission mails”. When the number exceeds, the transmission processing is suspended.

(S33-9): It is determined whether the transmission processing for package housing information file 22 is completed.

(S33-10): When transmission processing for package housing information file 22 is completed, package housing information file 22 having been transmitted is deleted from the “transmission file storage folder”.

On completion of the aforementioned procedure, mail transmission program unit 15 reaches the state of waiting for activation from mail transmission management program unit 14 (S33-11).

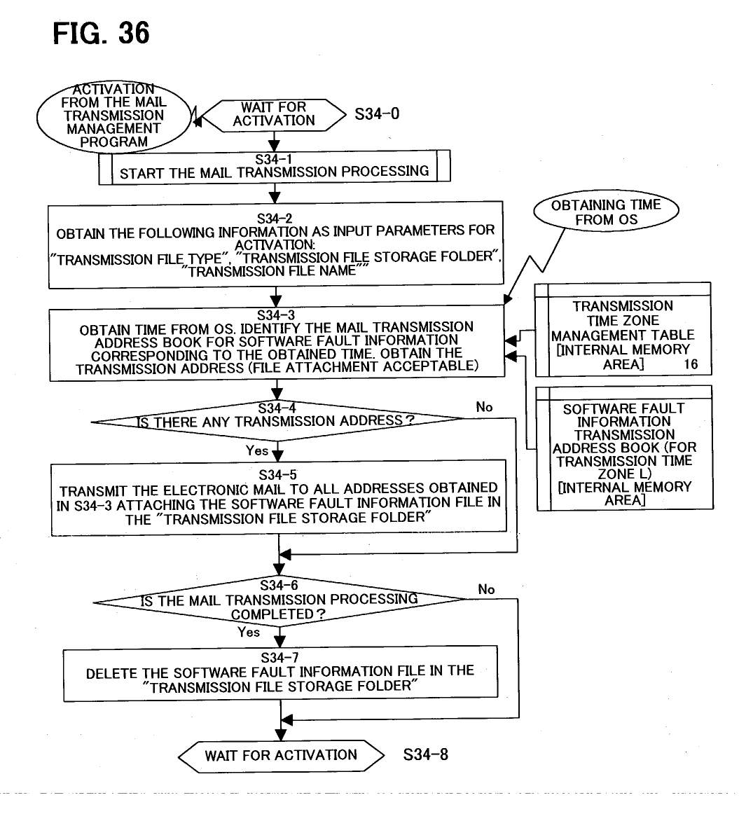

FIG. 36 illustrates a processing procedure up to when mail transmission program unit 15 executes mail transmission of software fault information file 23.

(S34-1): In the sate of waiting for activation (S34-0), mail transmission program unit 15 starts processing activated by mail transmission management program unit 14.

(S34-2): The following parameters are input as parameters at the time of activation from mail transmission management program unit 14.

“Transmission file type” (in this case, software fault information file)

“Transmission file storage folder”

“Transmission file name”

(S34-3): Mail transmission program unit 15 obtains current time from the OS to determine the time zone L (L=1-3) corresponding to the current time using transmission time zone management table 16.

Identifying the transmission address book for software fault information (transmission time zone L) corresponding to the time zone L using the mail transmission address book stored in the internal memory, mail transmission program unit 15 obtains a transmission address for software fault information (file attachment acceptable).

(S34-4) It is determined whether there is a setting of the transmission address for software fault information (file attachment acceptable).

(S34-5): The file having a file name identical to the file name of “transmission file name” stored in “transmission file storage folder” is transmitted as an attached file to the transmission address for software fault information (file attachment acceptable).

At this time, if there exist a plurality of transmission addresses for software fault information (file attachment acceptable), the file is transmitted to the entire addresses in broadcast form.

(S34-6): It is determined whether the transmission processing for software fault information file 23 is completed.

(S34-7): When transmission processing for software fault information file 23 is completed, software fault information file 23 having been transmitted is deleted from the “transmission file storage folder”.

On completion of the aforementioned procedure, mail transmission program unit 15 reaches the state of waiting for activation from mail transmission management program unit 14 (S34-8).

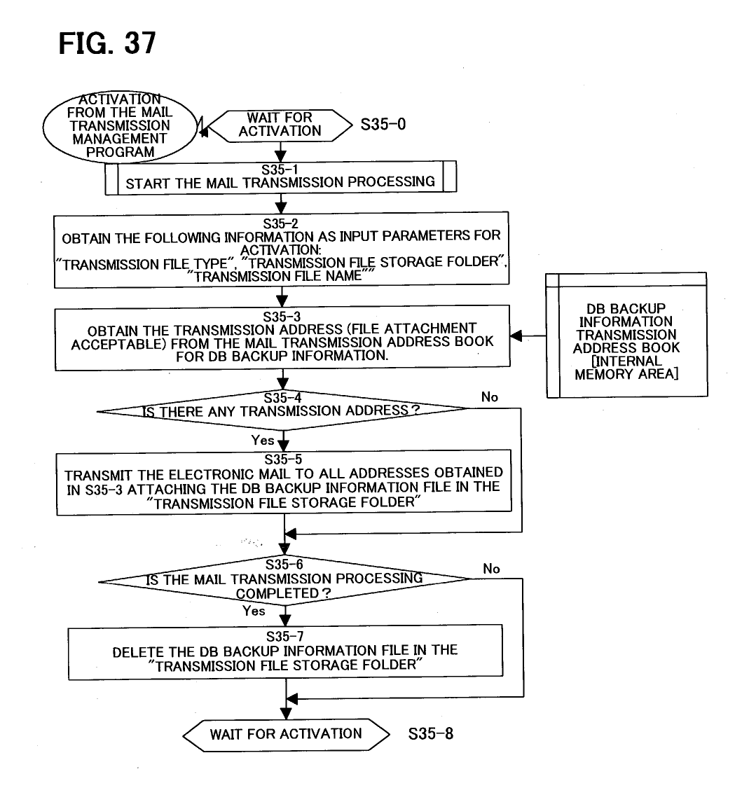

FIG. 37 illustrates a processing procedure up to when mail transmission program unit 15 executes mail transmission of DB backup information file 24.

(S35-1): In the sate of waiting for activation (S35-0), mail transmission program unit 15 starts processing activated by mail transmission management program unit 14.

(S35-2): The following parameters are input as parameters at the time of activation from mail transmission management program unit 14.

“Transmission file type” (in this case, DB backup information file)

“Transmission file storage folder”

“Transmission file name”

(S35-3): Identifying the transmission address book for DB backup information stored in the internal memory, mail transmission program unit 15 obtains a transmission address for DB backup information (file attachment acceptable).

(S35-4): It is determined whether there is a setting of the transmission address for DB backup information (file attachment acceptable).

(S35-5): The file having a file name identical to the file name of “transmission file name” stored in “transmission file storage folder” is transmitted as an attached file to the transmission address for DB backup information (file attachment acceptable).

At this time, if there exist a plurality of transmission addresses for DB backup information (file attachment acceptable), the file is transmitted to the entire addresses in broadcast form.

(S35-6): It is determined whether the transmission processing for DB backup information file 24 is completed.

(S35-7): When transmission processing for DB backup information file 24 is completed, DB backup information file 24 having been transmitted is deleted from the “transmission file storage folder”.

On completion of the aforementioned procedure, mail transmission program unit 15 reaches the state of waiting for activation from mail transmission management program unit 14 (S35-8).

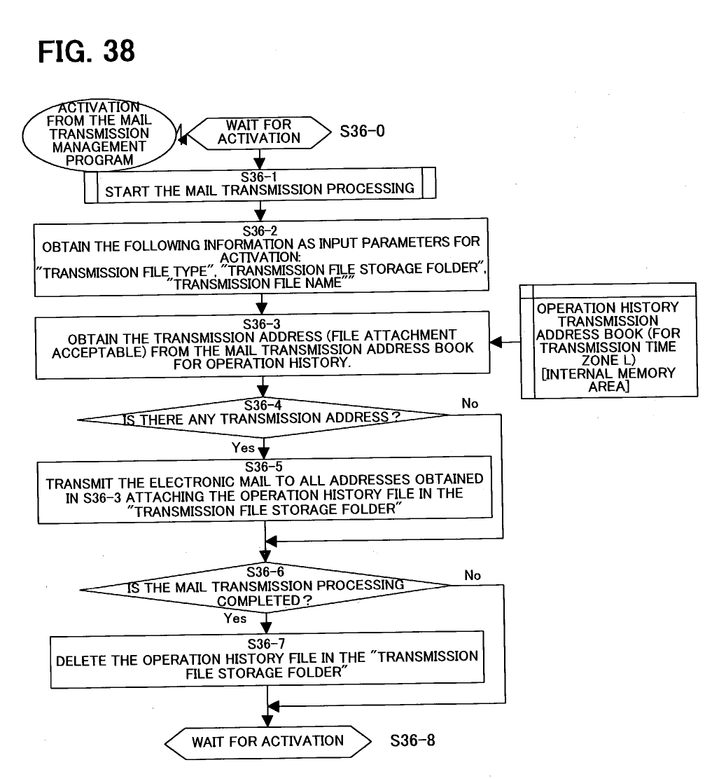

FIG. 38 illustrates a processing procedure up to when mail transmission program unit 15 executes mail transmission of operation history file 25.

(S36-1): In the sate of waiting for activation (S36-0), mail transmission program unit 15 starts processing activated by mail transmission management program unit 14.

(S36-2): The following parameters are input as parameters at the time of activation from mail transmission management program unit 14.

“Transmission file type” (in this case, operation history file)

“Transmission file storage folder”

“Transmission file name”

(S36-3): Identifying the transmission address book for operation history stored in the internal memory, mail transmission program unit 15 obtains a transmission address for operation history (file attachment acceptable).

(S36-4): It is determined whether there is a setting of the transmission address for operation history (file attachment acceptable).

(S36-5) The file having a file name identical to the file name of “transmission file name” stored in “transmission file storage folder” is transmitted as an attached file to the transmission address for operation history (file attachment acceptable).

At this time, if there exist a plurality of transmission addresses for operation history (file attachment acceptable), the file is transmitted to the entire addresses in broadcast form.

(S36-6): It is determined whether the transmission processing for operation history file 25 is completed.

(S36-7): When transmission processing for operation history file 25 is completed, operation history file 25 having been transmitted is deleted from the “transmission file storage folder”.

On completion of the aforementioned procedure, mail transmission program unit 15 reaches the state of waiting for activation from mail transmission management program unit 14 (S36-8).

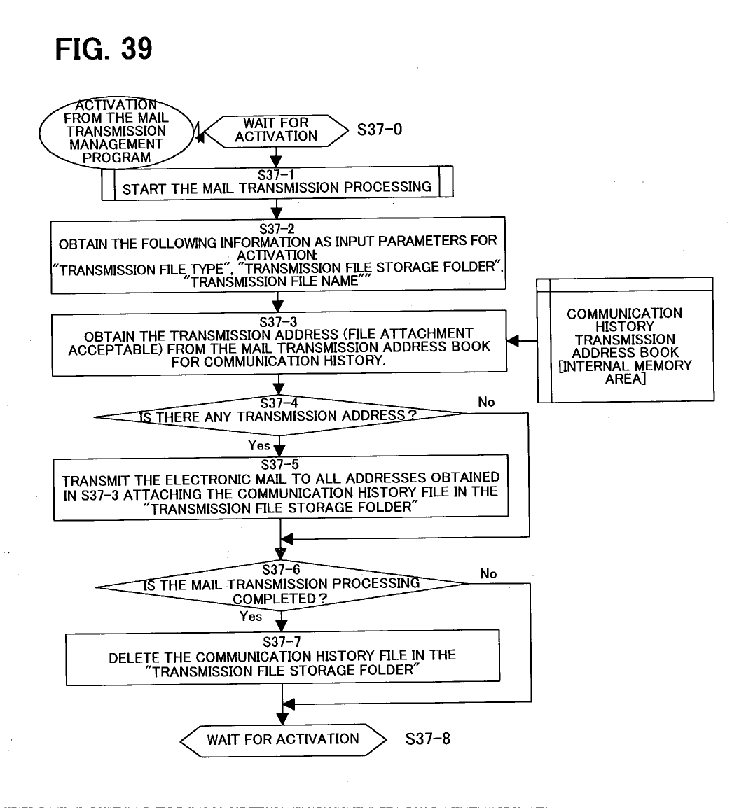

FIG. 39 illustrates a processing procedure up to when mail transmission program unit 15 executes mail transmission of communication history file 26.

(S37-1): In the sate of waiting for activation (S37-0), mail transmission program unit 15 starts processing activated by mail transmission management program unit 14.

(S37-2): The following parameters are input as parameters at the time of activation from mail transmission management program unit 14.

“Transmission file type” (in this case, communication history file)

“Transmission file storage folder”

“Transmission file name”

(S37-3): Identifying the transmission address book for communication history stored in the internal memory, mail transmission program unit 15 obtains a transmission address for communication history (file attachment acceptable).

(S37-4): It is determined whether there is a setting of the transmission address for communication history (file attachment acceptable).

(S37-5): The file having a file name identical to the file name of “transmission file name” stored in “transmission file storage folder” is transmitted as an attached file to the transmission address for communication history (file attachment acceptable).

At this time, if there exist a plurality of transmission addresses for communication history (file attachment acceptable), the file is transmitted to the entire addresses in broadcast form.

(S37-6): It is determined whether the transmission processing for communication history file 26 is completed.

(S37-7): When transmission processing for communication history file 26 is completed, communication history file 26 having been transmitted is deleted from the “transmission file storage folder”.

On completion of the aforementioned procedure, mail transmission program unit 15 reaches the state of waiting for activation from mail transmission management program unit 14 (S37-8).

The description mentioned above is the embodiment related to prompt transmission of fault information, etc. according to the present invention.

By applying the aforementioned data structure and processing procedure, it becomes possible to configure supervision and control operation system 1 having a means for solving the problem in the prior art.

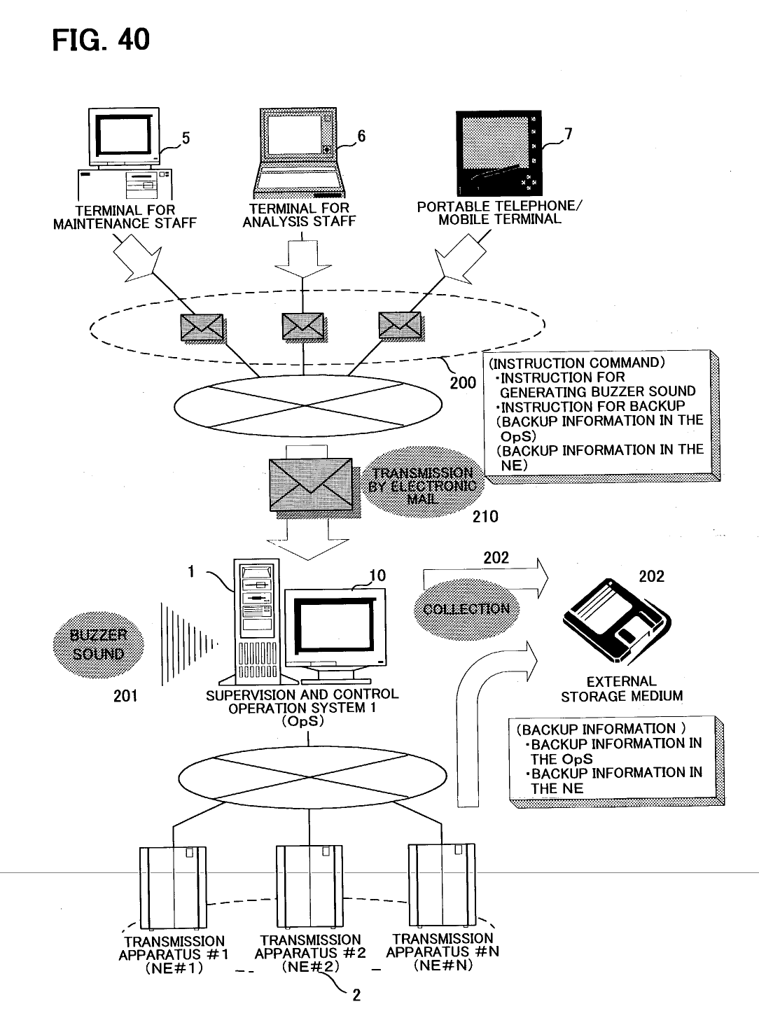

FIG. 40 shows a processing flow of a command for emergency measure for use when a serious fault occurs in the aforementioned embodiment. When an electronic mail related to serious fault information is received, an electronic mail 200 is returned to supervision and control operation system 1 from the received terminal, i.e. either terminal 5 for maintenance staff, terminal 6 for staff in charge of analysis, or portable telephone/mobile terminal 7. This initiates to ring a buzzer 201 or save DB backup information and backup information of transmission apparatus into external storage medium 202.

With these procedures, it becomes possible to issue an alarm by a buzzer without making a staff place at the front of supervision and control operation system 1 or remote supervision and control terminal 3. Also it becomes possible to obtain an effect of early protection from complete loss of backup data.

In the aforementioned embodiment, in response to electronic mail 200 received from terminal 5 for maintenance staff, terminal 6 for staff in charge of analysis, portable telephone/mobile terminal 7 which received the serious alarm information, a command for emergency measure is transmitted to supervision and control operation system 1 by electronic mail 210 in a predetermined form.

On receipt of this electronic mail 210, supervision and control operation system 1 performs an emergency measure corresponding to a command code described in the mail text.

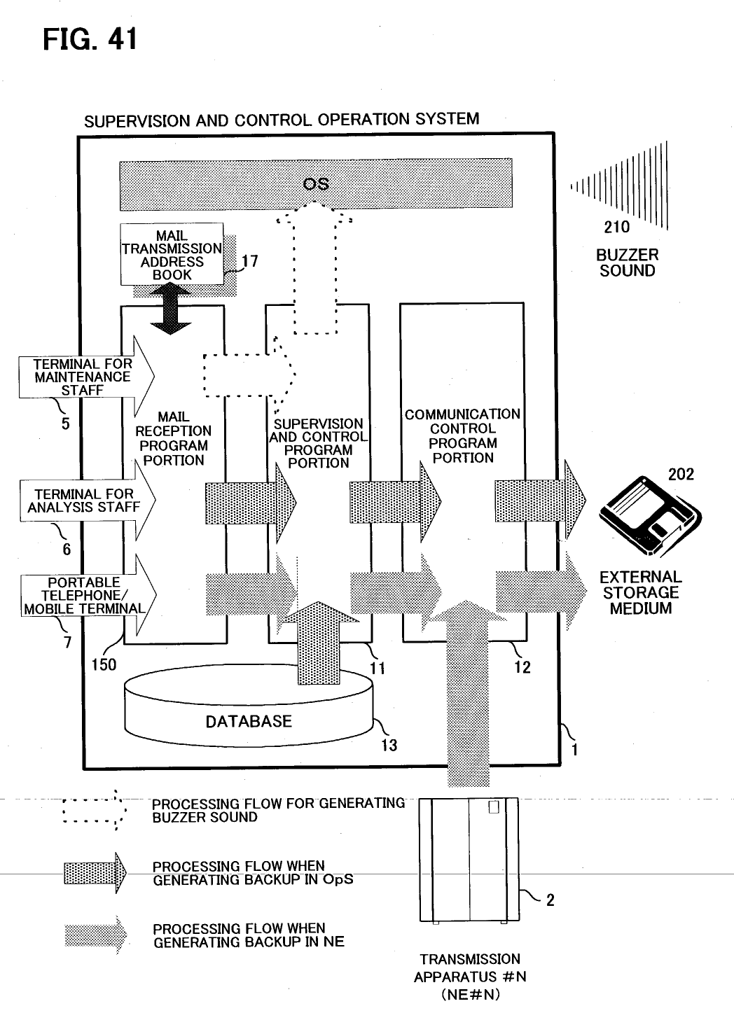

FIG. 41 shows an exemplary program configuration when executing the command for emergency measure. In this embodiment, the following processing is exemplified as an emergency measure.

Buzzer ringing processing 201: Beep sound from a buzzer mounted on a terminal of supervision and control operation system 1 is generated via the OS.

This enables to notify with an auditory means the occurrence of abnormal condition in an operation station in which supervision and control operation system 1 is introduced.

Database backup processing 202 in supervision and control operation system 1: In general, the terminal of supervision and control operation system 1 has a hardware redundant configuration using RAID structure or the like. Therefore, complete stoppage of operation caused by a single fault in a hard disk does not occur.

However, when another hard disk remaining in normality becomes faulty before replacing the hard disk having the preceded fault, the database information in which operation information of supervision and control operation system 1 is stored is lost.

Considering such a case as mentioned above, desirably the database information having operation information is to be made backup in external storage medium 202 immediately after a single hard disk fault occurs.

On receipt of an alarm caused by the hard disk fault occurring in supervision and control operation system 1 at terminal 5 for maintenance staff, portable telephone/mobile terminal 7, etc. through the fault notification procedure mentioned above, the maintenance staff starts to execute this command by replying an electronic mail.

Through this means, backup execution of database 13 is achieved without intervened by an application program in supervision and control operation system 1 or remote supervision and control terminal 3.

It is possible that the execution from a portable telephone/mobile terminal 7 is initiated from a place away from the office, home, etc.

Backup information uploading processing in transmission apparatus 2: In transmission apparatus 2, a file package in which backup operation information in the apparatus is stored, or a package on which the file unit is mounted, generally has a redundant configuration such as duplication.

Therefore, the data is not lost by a fault in a package on one side.

However, when the other package remaining in normality becomes faulty before replacing the package having the preceded fault, the operation information stored in the apparatus is lost. Considering such a case, desirably the backup information in the file unit having operation information is to be made backup into external storage medium 202 immediately after a package fault occurs on one side.

On receipt of an alarm caused by the fault in either the file package or the package mounting the file unit having occurred in transmission apparatus 2, at terminal 5 for maintenance staff, portable telephone/mobile terminal 7, etc. through mail program reception unit 150, the maintenance staff starts to execute this command by replying an electronic mail.

Through this means, uploading of the backup information stored in transmission apparatus 2 can be achieved without intervened by an application program in supervision and control operation system 1 or remote supervision and control terminal 3. It is also possible that the execution from a portable telephone/mobile terminal 7 is initiated from a place away from the office, home, etc.

Hereafter, the processing procedure for performing the aforementioned processing for emergency measure is described.

[Description Format in a Mail Text When Executing the Command for Emergency Measure]

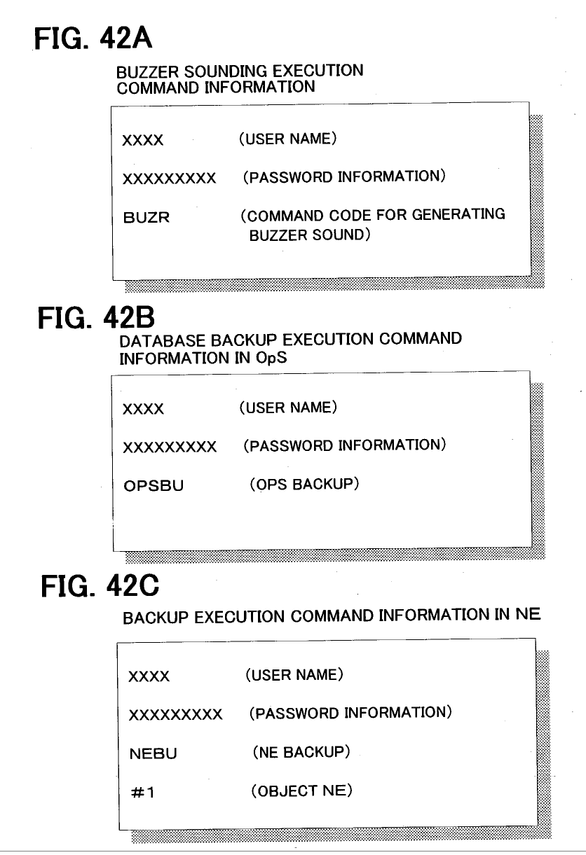

FIG. 42 illustrates an exemplary command description format in an electronic mail (for reply) when executing each emergency measure. FIG. 42A shows buzzer sounding execution command information, FIG. 42B shows database backup execution command information, and FIG. 42C shows backup execution command information in transmission apparatus.

In these command information sets, description items are as shown below:

[User name]: In supervision and control operation system 1, users are prepared for logging in the system. Here, among these registered users, a user name corresponding to a maintenance staff transmitting a mail is described.

[Password]: A password corresponding to the aforementioned user is registered. An identical password for use in logging into supervision and control operation system 1 is described.

[Command code]: A command code for execution is described.

[Object NE]: Transmission apparatus (NE) name to which the backup information of transmission apparatus 2 is uploaded is described. For this transmission apparatus name, any information by which the transmission apparatus as an uploading object can be identified uniquely, such as registration name, apparatus name, etc., may be used.

By these information sets mentioned above, it becomes possible to add information for execution to an electronic mail text without intervention of a complicated application program.

[Mail Reception Program Processing when Receiving a Command for Emergency Measure]

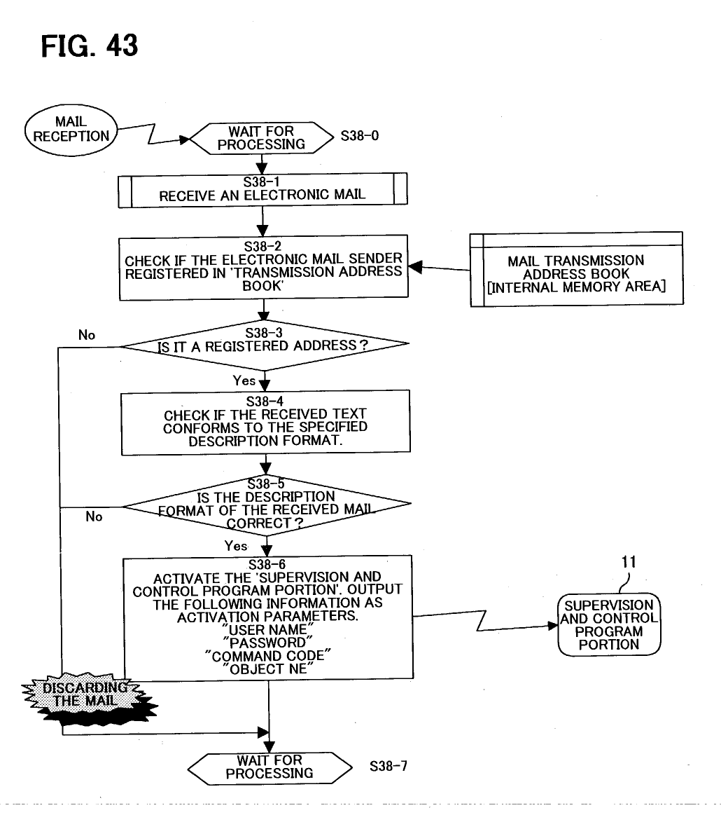

FIG. 43 illustrates a processing procedure of mail reception program unit 150 from when an emergency measure command is received to when a request for processing is issued to supervision and control program unit 11.

(S38-1): In the state of waiting for processing (S38-0), mail reception program unit 150 is activated on receipt of electronic mail 210.

(S38-2): It is checked whether the sender of the received electronic mail 210 is included in the addresses having been registered in the mail transmission address book shown in FIGS. 5-11.

(S38-3): If the address is not registered, the received mail is discarded. Thus, any mail having been transmitted either by mistake or from an address not registered in the mail transmission address book is discarded at this time.

(S38-4): The description information in the text of the received electronic mail is fetched, to check the description conforms to the exemplary description format shown in FIG. 41.

(S38-5): The electronic mail of which description format is not correct is discarded.

(S38-6): Supervision and control program unit 11 is activated. At this time, the following information is set as input information to supervision and control program unit 11.

“User name”

“Password”

“Command code”

“Object NE”

On completion of the above-mentioned procedure, mail reception program unit 150 reaches the state of waiting for activation by electronic mail reception (S38-7).

[Processing in the Supervision and Control Program Unit on Receipt of an Emergency Measure Command]

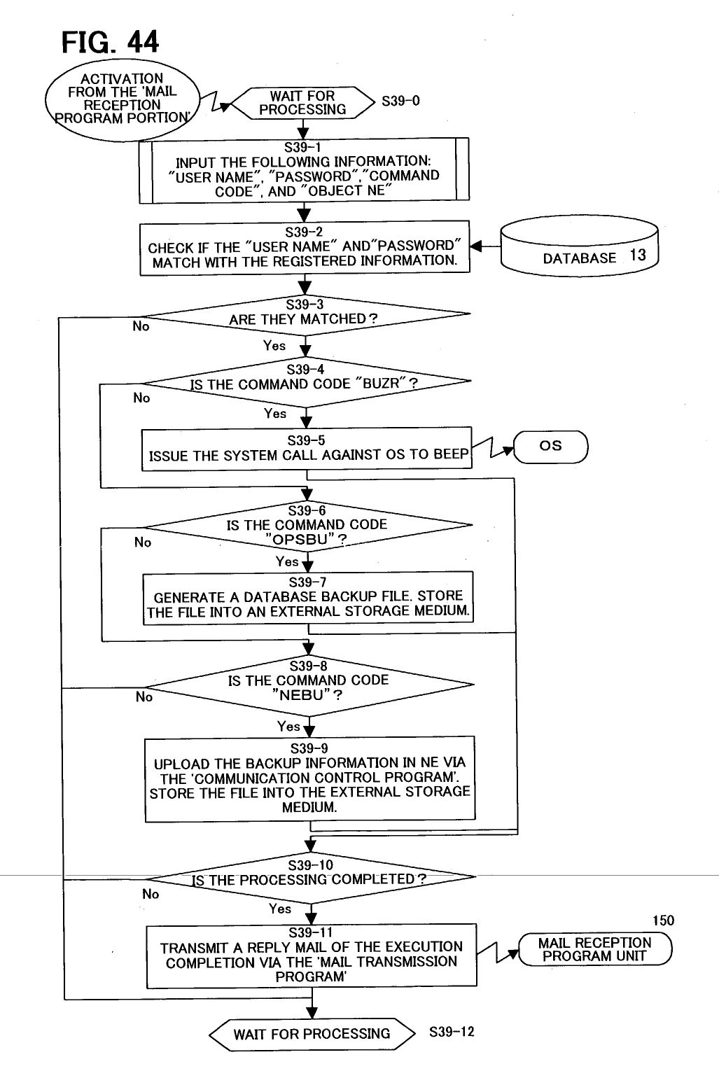

FIG. 44 illustrates a processing procedure from when supervision and control program unit 11 is activated from mail reception program unit 150 to when an emergency measure command is actually executed.

(S39-1): In the state of waiting for processing (S39-0), supervision and control program unit 11 starts processing activated by mail reception program unit 150.

At this time, the following information is input as activation parameters.

“User name”

“Password”

“Command code”

“Object NE”

(S39-2): It is checked whether the “user name” and the “password” match with the information for use when logging into supervision and control operation system 1. Here, these information sets are preserved in database 13.

(S39-3): If the “user name” or the “password” does not match, the emergency measure command is treated invalid, and the procedure reaches the state of waiting for processing (S39-12).

(S39-4): It is checked whether the “command code” is a command code instructing the buzzer ringing processing.

(S39-5): When the command code corresponds to the buzzer ringing processing, a system call to beep on the terminal is issued to the OS. If the command code does not correspond to the buzzer ringing processing, the procedure proceeds to processing (S39-6).

(S39-6): It is checked whether the “command code” is a command code instructing the backup processing of the database information in supervision and control operation system 1.

(S39-7): When the command code instructs the database information backup in supervision and control operation system 1, a backup file against database 13 is generated to store into external storage medium 202 such as an MO, an external hard disk or the like. If the command code does not correspond, the procedure proceeds to processing (S39-8).

(S39-8): It is checked whether the “command code” is a command code instructing the operation information backup in transmission apparatus 2.

(S39-9): When the command code instructs the operation information backup in transmission apparatus 2, the backup data of the operation information is uploaded from transmission apparatus 2 corresponding to “Object NE”, to generate a backup file.

The backup file is stored into external storage medium 202 such as an MO, an external hard disk or the like.

(S39-10): When any one of the above-mentioned processing (S39-5), (S39-7) and (S39-9) is completed normally, an electronic mail for reply indicating the normal completion (“OK”, “Execution completed”, etc.) is transmitted via mail transmission program unit 15 shown in FIG. 3 to the mail address which originated the command for emergency measure. On completion of the above-mentioned procedure, supervision and control program unit 11 reaches to the state waiting for processing (S39-12). As

As the embodiment of the present invention having been described, the present invention has an effect that, by applying the processing procedure in regard to the emergency measure command execution, it becomes possible to notify a fault on transmission apparatus and a network, and also to perform the processing corresponding to a fault notification in a prompt and simplified manner.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A transmission network system comprising:
a plurality of transmission apparatus connected to a network; and
a supervision and control operation system connected to the network,
the supervision and control operation system including a means for transmitting information related to a network alarm or a package housing change, which is detected by the transmission apparatus to a predetermined mail address via an electronic mail.

2. A transmission network system comprising:
a plurality of transmission apparatus connected to a network; and
a supervision and control operation system connected to the network,
the supervision and control operation system including a means for transmitting software fault information detected by the supervision and control operation system to a predetermined mail address via an electronic mail.

3. A transmission network system comprising:
a plurality of transmission apparatus connected to a network; and
a supervision and control operation system connected to the network,
the supervision and control operation system including a means for transmitting database backup information of the supervision and control operation system, which is collected automatically and periodically to a predetermined mail address via an electronic mail.

4. A transmission network system comprising:
a plurality of transmission apparatus connected to a network; and
a supervision and control operation system connected to the network,
the supervision and control operation system including; a means for recording operation information executed from a control terminal to the supervision and control operation system; and a means for transmitting an operation history recorded by the recording means to a predetermined mail address via an electronic mail.

5. A transmission network system comprising:
a plurality of transmission apparatus connected to a network; and
a supervision and control operation system connected to the network,
the supervision and control operation system including; a means for recording communication information related to command transmission and reception, and event transmission and reception performed between the supervision and control operation system and a control terminal or the transmission apparatus; and
a means for transmitting a communication history recorded by said recording means to a predetermined mail address via an electronic mail.

6. The transmission network system according to claim 1 wherein said predetermined mail address is selected according to the time zone when said network alarm is issued.

7. The transmission network system according to any one of claim 1 to 6, wherein said information to be transmitted by said transmission means via the electronic mail is transmitted either in the form of a mail text or an attached file.

8. The transmission network system according to any one of claim 1 to 6 wherein when said transmitted information is a predetermined serious alarm, alarm sound is produced at a terminal corresponding to the destination mail address.

9. The transmission network system according to any one of claim 1 to 6, wherein when said transmitted information is a predetermined serious alarm, a means is further comprised for storing database backup information of said supervision and control operation system into an external storage medium in an external storage of a terminal corresponding to the destination mail address.
